(19) United States
(12) Patent Application Publication
(10) Pub. No.: US 2007/0054981 A1
(43) Pub. Date: Mar. 8, 2007

(54) Ink set and method and apparatus for recording image

(75) Inventors: Terukazu Yanagi, Ashigara-Kami-Gun (JP); Hirotaka Kitagawa, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd, Minami-Ashigara-shi (JP)

(21) Appl. No.: 11/515,762

(22) Filed: Sep. 6, 2006

(30) Foreign Application Priority Data
Sep. 7, 2005 (JP) 2005-259925

(51) Int. Cl. C03C 17/00; C09D 11/00

(52) U.S. Cl. 523/160; 523/161

(57) ABSTRACT

An ink set comprising an ink containing at least an organic pigment, a water-soluble organic solvent and water and a treating liquid which is applied to a recording medium before applying the ink to the recording medium and produces an agglomerate upon contact with the ink, the ink containing a low molecular weight dispersant having a molecular weight of 2000 or lower and polymer fine particles.

### BACKGROUND OF THE INVENTION

1. Field of the Invention

The present invention relates to an ink set and a method and an apparatus for recording an image, and in particular, an ink set for inkjet and a method and an apparatus for recording an image, which are excellent in discharge stability of the ink and suitable for high speed printing.

2. Description of the Related Art

Recently, inkjet recording technology is growing rapidly and its application to the printing field is now being studied. Due to such development, the current inkjet printing technology has become capable of forming high quality, high definition images comparable to silver halide printings. However, for further application of the technology to the printing field, the problem is high speed printing and compatibility between ink and recording medium.

In the printing field, so-called art paper or coated paper (hereinafter printing paper) is generally used. Such printing paper has a characteristic that liquid components in the ink (particularly water) are difficult to be absorbed. Accordingly, when current aqueous inkjet ink is used, blurring of the ink on the paper is remarkable and image quality is significantly deteriorated.

Thus, to achieve high speed printing, a process for removing a solvent by heat drying immediately after printing is required. Heat drying, however, has a problem of high energy consumption, and to reduce the load of drying, high concentration pigment ink must be developed.

On the other hand, recording methods in which blurring of ink is prevented include a shuttle method, which is a major method of the current inkjet recording methods. The shuttle method is composed of ejecting an ink dot and then taking time to infiltrate the ejected ink into paper before ejecting the next dot, thereby preventing merger of a dot with an adjacent dot (hereinafter drop interference). However, this involved a problem that printing takes long time and high speed printing is difficult.

In addition to the shuttle method, printing methods also include a page-wide single pass method, which is capable of high speed printing. Since the time before ejecting an adjacent dot is extremely short in this method, the method is relatively advantageous for high speed printing. However, the method had a defect that drop interference easily occurs and image quality is easily deteriorated.

For solving the above problems, a two component method is now proposed, in which a treating liquid which produces an agglomerate with ink upon contact with the ink is ejected or applied to a recording medium, thereby preventing drop interference.

For example, Japanese Patent Application Laid-Open No. 2000-272220 discloses an inkjet recording method in which ink containing a pigment and polymer fine particles is combined with a treating liquid containing a reactive agent which produces an agglomerate upon contact with the ink. The publication describes that the method improves the scratch resistance, the water resistance and the discharge stability of the ink.

Further, Japanese Patent Application Laid-Open No. 2000-290553 discloses an ink containing a pigment and a resin emulsion. The publication describes that the ink has excellent storage stability.

However, when a high molecular weight dispersant is used for ink (particularly high concentration pigment ink) as in Japanese Patent Application Laid-Open Nos. 2000-272220 and 2000-290553, the viscosity of the ink significantly increases upon addition of polymer fine particles or resin emulsion. This caused a problem that ink could not be discharged well in inkjet. Moreover, since drop interference could not be completely prevented, high speed printing was difficult.

The present invention has been made in view of such circumstances and provides an ink set and a method and an apparatus for recording an image excellent in discharge stability of the ink and capable of forming high quality, high definition images at high speed.

### SUMMARY OF THE INVENTION

To attain the aforementioned object, according to a first aspect of the present invention, there is provided an ink set comprising an ink comprising at least an organic pigment, a water-soluble organic solvent and water and a treating liquid which is applied to a recording medium before applying the ink to the recording medium and produces an agglomerate upon contact with the ink, the ink containing a low molecular weight dispersant having a molecular weight of 2000 or lower and polymer fine particles.

Since the first aspect of the present invention has a construction that a pigment is dispersed using a low molecular weight dispersant instead of a high molecular weight dispersant, the viscosity of high concentration ink can be lowered. In addition, since the ink contains polymer fine particles, fixing properties of the ink to a recording medium, scratch resistance and water resistance can be ensured. This makes it possible to produce an ink having high concentration and low viscosity without deteriorating fixing properties, scratch resistance and water resistance, and therefore the ink has excellent discharge stability, enabling formation of high quality, high definition images at high speed. In addition, since an agglomerate is formed upon contact with a treating liquid, drop interference due to blurring of ink can be prevented, making high speed printing possible.

In the first aspect, the molecular weight of the low molecular weight dispersant can be determined by calculation from the composition formula. The low molecular weight dispersant has a molecular weight of preferably 100 to 2000, more preferably 200 to 2000.

According to a second aspect of the present invention, there is provided the ink set according to the first aspect, wherein the treating liquid is acidic.

In the second aspect, ink is brought into contact with an acidic treating liquid to change the acidity (pH) of the ink, thereby inducing an agglomeration reaction. Since the ink forms an agglomerate as herein described, drop interference can be prevented. Further, since the change in the pH of the ink is caused by the movement of hydrogen ions which are the smallest atom, the agglomeration reaction occurs at high speed. Accordingly, high speed printing becomes possible. The treating liquid has a pH of preferably 1 to 6, more preferably 2 to 5, and further preferably 3 to 5.

According to a third aspect of the present invention, there is provided the ink set according to the first or second aspect, wherein the low molecular weight dispersant has a pKa relative to a dissociation constant Ka of 3 or more.

In the third aspect, pKa is represented by pKa=−log(Ka) when the dissociation constant in a dissociation reaction of acid (HA→H⁺+A⁻, H⁺: molar concentration of hydrogen ions, A⁻: molar concentration of anionic groups) is Ka=[H⁺][A⁻]/[HA].

According to the third aspect, theoretically 50% or more of anionic groups in the low molecular weight dispersant is unassociated upon contact with a treating liquid having a pH of about 3 (namely, equal to pKa), causing an agglomeration reaction. Accordingly, drop interference of the ink can be prevented and high speed printing becomes possible. In addition, since the water solubility of anionic groups of the low molecular weight dispersant decreases at that time, the water resistance can be improved.

Also, practically when the low molecular weight dispersant has a pKa of lower than 3, agglomeration reaction is difficult to proceed unless the acidic treating liquid also has a pH of lower than 3. However, when the pH of the treating liquid is too low (strong acid), there is a possibility of corrosion of inkjet heads. Accordingly, to ensure durability of the head, the low molecular weight dispersant of the third aspect is preferably used.

According to a fourth aspect of the present invention, there is provided the ink set according to any one of the first to third aspects, wherein the low molecular weight dispersant has a chemical structure containing a carboxylic acid group or a salt thereof.

According to the fourth aspect, since the range of pKa of the low molecular weight dispersant in the third aspect is satisfied, drop interference is prevented and high speed printing becomes possible. Further, since a low molecular weight dispersant containing a carboxylic acid group is easily synthesized or produced, ink can be provided at a low cost.

According to a fifth aspect of the present invention, there is provided the ink set according to any one of the first to fourth aspects, wherein the low molecular weight dispersant is represented by the Formula (1).

According to a sixth aspect of the present invention, there is provided the ink set according to the fifth aspect, wherein L¹ in the Formula (1) is an amide group, a sulfonamide group, an ester group, an ether group or a sulfide group.

According to a seventh aspect of the present invention, there is provided the ink set according to any one of the first to sixth aspects, wherein the low molecular weight dispersant is represented by the Formula (2) or (3).

The fifth to seventh aspects define preferred structures of the low molecular weight dispersant in the present invention. By adding the low molecular weight dispersant according to the fifth to seventh aspects, preferably the low molecular weight dispersant according to the seventh aspect to ink, ink excellent in dispersibility of an organic pigment and discharge stability can be obtained.

According to an eighth aspect of the present invention, there is provided the ink set according to any one of the first to seventh aspects, wherein the polymer fine particles have a glass transition temperature Tg of 30° C. or higher.

When polymer fine particles have a glass transition temperature Tg of lower than 30° C., polymer fine particles soften at room temperature, adhere with each other or form a film, producing a coarse matter in the inkjet head. As a result, the head suffers from clogging and the discharge stability of the ink is reduced.

According to the eighth aspect, since polymer fine particles having a glass transition temperature Tg of room temperature (about 30° C. or lower) or higher is used, ink can be discharged well even at room temperature.

According to a ninth aspect of the present invention, there is provided the ink set according to any one of the first to eighth aspects, wherein the polymer fine particles are a styrene latex or an acrylic latex.

By using the polymer latex of the ninth aspect, fixing properties, scratch resistance and water resistance of low viscosity ink can also be ensured. Accordingly, ink can be discharged well, and high quality, high definition images can be formed. A latex of a styrene-butadiene copolymer and a latex of a styrene-isoprene copolymer are preferred as the styrene latex, and a styrene-butadiene copolymer is more preferred.

According to a tenth aspect of the present invention, there is provided the ink set according to any one of the first to ninth aspects, wherein the mass ratio P/C of a mass P of the polymer fine particles contained in the ink to a mass C of the organic pigment contained in the ink is 0.5 to 4.0.

When the amount added of polymer fine particles relative to the organic pigment contained in the ink is too small, scratch resistance and fixing properties are deteriorated. On the other hand, when the amount added of polymer fine particles is too large, the viscosity of the ink suddenly increases and the dischargeability is deteriorated. According to the tenth aspect, the discharge stability of the ink can be improved while maintaining the scratch resistance and the fixing properties of the ink.

According to an eleventh aspect of the present invention, there is provided the ink set according to any one of the first to tenth aspects, wherein the ink contains a fluorine surfactant.

According to the eleventh aspect, since a fluorine surfactant is added, the scratch resistance and the discharge stability of the ink can be improved. Preferably, the fluorine surfactant is added so that the surface tension of the ink is adjusted to 20 to 60 mN/m to achieve good discharge stability of the ink.

According to a twelfth aspect of the present invention, there is provided the ink set according to any one of the first to eleventh aspects, which is an ink set for inkjet.

According to the twelfth aspect, the ink can be discharged in a stable manner and drop interference can be prevented in inkjet. Accordingly, high speed printing with high quality and high definition can be achieved.

To attain the aforementioned object, according to a thirteenth aspect of the present invention, there is provided a method for recording an image using the ink set according to any one of the first to twelfth aspects, which comprises applying the treating liquid in the ink set to a recording medium and then applying the ink in the ink set to the treating liquid, thereby forming an image.

In the thirteenth aspect of the present invention, a low viscosity ink excellent in discharge stability and a treating liquid, which are the ink set according to the present invention, are brought into contact on a recording medium to produce an agglomerate, thereby forming an image. Accordingly, the ink has excellent discharge stability, and high quality, high definition images can be formed at high speed.

According to a fourteenth aspect of the present invention, there is provided the method for recording an image according to the thirteenth aspect, wherein the treating liquid is acidic and the acidity of the ink changes upon contact with the treating liquid to produce an agglomerate.

According to the fourteenth aspect, agglomeration reaction proceeds rapidly by bringing an ink into contact with a treating liquid. As a result, drop interference can be prevented. The pH of the treating liquid is changed to the same pH as in the second aspect.

According to a fifteenth aspect of the present invention, there is provided the method for recording an image according to the thirteenth or fourteenth aspect, which is an inkjet recording method.

According to the fifteenth aspect, ink can be discharged in a stable manner even in inkjet, and due to contact with a treating liquid, drop interference can be prevented. Accordingly, high speed printing becomes possible with high quality and high definition.

To attain the aforementioned object, according to a sixteenth aspect of the present invention, there is provided an apparatus for recording an image using the ink set according to any one of the first to twelfth aspects, the apparatus comprising a first application device which applies the treating liquid in the ink set to a recording medium, a second application device which applies the ink in the ink set to the treating liquid and a heating device which heats an agglomerate produced upon contact between the ink and the treating liquid.

The sixteenth aspect provides an apparatus for recording an image using the ink set according to the present invention. According to the sixteenth aspect, by heating an agglomerate to a pre-determined temperature or higher by the heating device, polymer fine particles in the agglomerate are dried and cured. With this procedure, polymer fine particles dispersed together with an organic pigment can be combined with each other to form a film, and fixing properties to a recording medium, scratch resistance and water resistance can be improved.

The ink set according to the present invention makes it possible to produce an ink having high concentration and low viscosity without deteriorating fixing properties, scratch resistance and water resistance. Thus, according to the method and the apparatus for recording an image of the present invention, high quality, high definition images can be formed at high speed with excellent ink discharge stability.

### BRIEF DESCRIPTION OF THE DRAWINGS

FIG. 1 is an entire structural view of an inkjet recording apparatus which is an embodiment of an apparatus for forming an image;

FIGS. 2A and 2B are perspective plan views illustrating an example of a structure of a printing head;

FIG. 3 is a perspective plan view illustrating another example of a structure of a full-line printing head;

FIG. 4 is a cross sectional view taken on line 4-4 in FIGS. 2A and 2B;

FIG. 5 is an enlarged view of a nozzle arrangement of the printing head shown in FIGS. 2A and 2B;

FIG. 6 is a schematic view illustrating a configuration of an ink feeding system in an inkjet recording apparatus;

FIG. 7 is a block diagram of essential parts illustrating a system configuration of an inkjet recording apparatus; and

FIG. 8 is a schematic view illustrating a process for forming an image in the inkjet recording apparatus of the present invention.

### DETAILED DESCRIPTION OF THE PREFERRED EMBODIMENTS

First, the ink set according to the present invention is described in detail.

[Composition of Ink]

(Low Molecular Weight Dispersant)

The low molecular weight dispersant used in this embodiment is added in order to disperse an organic pigment in an aqueous solvent in a stable state with maintaining the ink at low viscosity. The low molecular weight dispersant used in this embodiment has a molecular weight of 2000 or lower. The low molecular weight dispersant has a molecular weight of preferably 100 to 2000, more preferably 200 to 2000.

In this embodiment, the low molecular weight dispersant has a structure containing a hydrophilic group and a hydrophobic group. The low molecular weight dispersant may contain one or more hydrophilic group and one or more hydrophobic group per molecule, or plural kinds of hydrophilic groups and hydrophobic groups. The low molecular weight dispersant may also contain a linking group for linking a hydrophilic group and a hydrophobic group.

The hydrophilic group is anionic, cationic, nonionic or betaine type in which those are combined.

Any anionic group may be used as long as it has negative charge, and a phosphate group, a phosphonate group, a phosphinate group, a sulfate group, a sulfonic acid group, sulfinate group and a carboxylic acid group are preferred, and a phosphate group or a carboxylic acid group is more preferred. A carboxylic acid group is still more preferred.

Any cationic group may be used as long as it has positive charge, and organic cationic substituents are preferred, and a cationic group of nitrogen or phosphorus is more preferred. In addition, a pyridinium cation or an ammonium cation is further preferred.

Examples of nonionic groups include part of polyethylene oxide, polyglycerol or a sugar unit.

In this embodiment, preferably the hydrophilic group is an anionic group. Preferably the anionic group is a phosphate group, a phosphonate group, a phosphinate group, a sulfate group, a sulfonic acid group, sulfinate group or a carboxylic acid group, and more preferably a phosphate group or a carboxylic acid group. A carboxylic acid group is still more preferred.

When the low molecular weight dispersant contains an anionic hydrophilic group, preferably the low molecular weight dispersant has a pKa of 3 or more for facilitating agglomeration reaction by bringing into contact with an acidic treating liquid. In the present invention, the pKa of the low molecular weight dispersant is experimentally determined from a titration curve obtained by titration of a solution of the low molecular weight dispersant dissolved in tetrahydrofuran/water (tetrahydrofuran: water=3:2=V/V) at 1 mmol/L with an acid or alkaline solution. When the low molecular weight dispersant has a pKa of 3 or more, theoretically 50% or more of anionic groups is unassociated upon contact with a treating liquid having a pH of about 3. As a result, the water solubility of the low molecular weight dispersant is significantly decreased and agglomeration reaction occurs. In short, the agglomeration reactivity improves. The low molecular weight dispersant preferably has a carboxylic acid group as an anionic group in this view as well.

The hydrophobic group has a hydrocarbon, fluorocarbon or silicone structure, and in particular, a hydrocarbon structure is preferred. These hydrophobic groups may have a linear or branched structure. The hydrophobic group may have one or more chain structures. When the hydrophobic group has more than one chain structures, it may have plural kinds of hydrophobic groups.

For the hydrophobic group, hydrocarbon groups having 2 to 24 carbon atoms are preferred, hydrocarbon groups having 4 to 24 carbon atoms are more preferred, and hydrocarbon groups having 6 to 20 carbon atoms are further preferred.

The amount to be added of the low molecular weight dispersant is preferably within the range in which a pigment can be homogeneously dispersed in an aqueous solvent and ink can be steadily discharged. The mass ratio B/C of a mass B of the low molecular weight dispersant to a mass C of the organic pigment is preferably 0.0001 to 1, more preferably 0.0001 to 0.5, further preferably 0.0001 to 0.2. The ink has a viscosity of preferably 1 to 30 mPa·s, more preferably 1 to 20 mPa·s, further preferably 2 to 15 mPa·s, and particularly preferably 2 to 10 mPa·s.

Specific examples of low molecular weight dispersants suitably used in this embodiment include compounds represented by the following Formulas (1), (2) and (3), but the present invention is not limited to the following examples. Further, as described later, of the low molecular weight dispersants of the Formulas (1) to (3), low molecular weight dispersants represented by the Formulas (2) and (3) are preferred, and low molecular weight dispersants represented by the Formula (2) are more preferred.

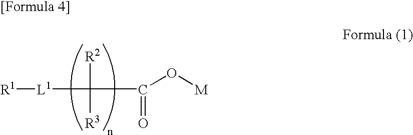

In the Formula (1), R¹ represents a substituent, R² and R³ each represent a hydrogen atom or a substituent; the sum of carbon atoms of R¹, R² and R³ is 13 or more, preferably 16 or more; M represents a hydrogen atom or a monovalent cation; L¹ represents a single bond or a divalent linking group; and preferably, the divalent linking group is an amide group, a sulfonamide group, an ester group, an ether group or a sulfide group, more preferably an amide group.

The substituents described below (hereinafter substituent T) can be used as the above-described substituent. Specific examples of substituents T include alkyl groups [linear, branched or cyclic substituted or unsubstituted alkyl groups including alkyl groups (preferably alkyl groups having 1 to 30 carbon atoms such as methyl, ethyl, n-propyl, isopropyl, t-butyl, s-butyl, n-hexyl, n-octyl, n-lauryl) and cycloalkyl groups (preferably substituted or unsubstituted cycloalkyl groups having 5 to 30 carbon atoms such as cyclohexyl, cyclopentyl, 4-n-dodecylcyclohexyl)], aryl groups (preferably substituted or unsubstituted aryl groups having 6 to 30 carbon atoms such as phenyl, p-dodecylphenyl, naphthyl, p-hexadecyloxyphenyl), heterocyclic groups (preferably monovalent groups obtained by removing a hydrogen atom from a 5 or 6-membered substituted or unsubstituted, aromatic or non-aromatic heterocyclic compound, more preferably 5 or 6-membered aromatic heterocyclic groups having 3 to 30 carbon atoms such as 2-furyl, 2-thienyl, 2-pyrimidinyl, 2-benzothiazolyl, pyridyl), a hydroxyl group, alkoxy groups (preferably substituted or unsubstituted alkoxy groups having 1 to 30 carbon atoms such as methoxy, ethoxy, isopropoxy, t-butoxy, n-octyloxy, 2-methoxyethoxy), aryloxy groups (preferably substituted or unsubstituted aryloxy groups having 6 to 30 carbon atoms such as phenoxy, 2-methylphenoxy, 4-t-butylphenoxy, 4-n-dodecyloxyphenoxy, 1-naphthoxy), heterocyclic oxy groups (preferably substituted or unsubstituted heterocyclic oxy groups having 2 to 30 carbon atoms such as 1-phenyltetrazole-5-oxy, 2-tetrahydropyranyloxy), acyloxy groups (preferably substituted or unsubstituted alkylcarbonyloxy groups having 2 to 30 carbon atoms, substituted or unsubstituted arylcarbonyloxy groups having 6 to 30 carbon atoms such as acetyloxy, pivaloyloxy, stearoyloxy, benzoyloxy, p-methoxyphenylcarbonyloxy), carbamoyloxy groups (preferably substituted or unsubstituted carbamoyloxy groups having 1 to 30 carbon atoms such as N,N-dimethylcarbamoyloxy, N,N-diethylcarbamoyloxy, morpholinocarbonyloxy, N,N-di-n-octylaminocarbonyloxy, N-n-octylcarbamoyloxy), alkoxycarbonyloxy groups (preferably substituted or unsubstituted alkoxycarbonyloxy groups having 2 to 30 carbon atoms such as methoxycarbonyloxy, ethoxycarbonyloxy, t-butoxycarbonyloxy, n-octylcarbonyloxy), aryloxycarbonyloxy groups (preferably substituted or unsubstituted aryloxycarbonyloxy groups having 7 to 30 carbon atoms such as phenoxycarbonyloxy, p-methoxyphenoxycarbonyloxy, p-n-hexadecyloxyphenoxycarbonyloxy), amino groups (preferably amino groups, substituted or unsubstituted alkylamino groups having 1 to 30 carbon atoms, substituted or unsubstituted arylamino [anilino] groups having 6 to 30 carbon atoms, such as amino, methylamino, dimethylamino, anilino, N-methyl-anilino, diphenylamino), acylamino groups (preferably substituted or unsubstituted alkylcarbonylamino groups having 2 to 30 carbon atoms, substituted or unsubstituted arylcarbonylamino groups having 6 to 30 carbon atoms such as acetylamino, pivaloylamino, lauroylamino, benzoylamino), aminocarbonylamino groups (preferably substituted or unsubstituted aminocarbonylamino groups having 1 to 30 carbon atoms such as carbamoylamino, N,N-dimethylaminocarbonylamino, N,N-diethylaminocarbonylamino, morpholinocarbonylamino), alkoxycarbonylamino groups (preferably substituted or unsubstituted alkoxycarbonylamino groups having 2 to 30 carbon atoms such as methoxycarbonylamino, ethoxycarbonylamino, t-butoxycarbonylamino, n-octadecyloxycarbonylamino, N-methyl-methoxycarbonylamino), aryloxycarbonylamino groups (preferably substituted or unsubstituted aryloxycarbonylamino groups having 7 to 30 carbon atoms such as phenoxycarbonylamino, p-chlorophenoxycarbonylamino, m-n-octyloxyphenoxycarbonylamino), sulfamoylamino groups (preferably substituted or unsubstituted sulfamoylamino groups having 0 to 30 carbon atoms such as sulfamoylamino, N,N-dimethylaminosulfonylamino, N-n-octylaminosulfonylamino), alkylsulfonylamino groups and arylsulfonylamino groups (preferably substituted or unsubstituted alkylsulfonylamino having 1 to 30 carbon atoms, substituted or unsubstituted arylsulfonylamino having 6 to 30 carbon atoms such as methylsulfonylamino, butylsulfonylamino, phenylsulfonylamino, 2,3,5-trichlorophenylsulfonylamino, p-methylphenylsulfonylamino), mercapto groups, alkylthio groups (preferably substituted or unsubstituted alkylthio groups having 1 to 30 carbon atoms such as methylthio, ethylthio, n-hexadecylthio), arylthio groups (preferably substituted or unsubstituted arylthio having 6 to 30 carbon atoms such as phenylthio, p-chlorophenylthio, m-methoxyphenylthio), heterocyclic thio groups (preferably substituted or unsubstituted heterocyclic thio groups having 2 to 30 carbon atoms such as 2-benzothiazolylthio, 1-phenyltetrazole-5-ylthio), sulfamoyl groups (preferably substituted or unsubstituted sulfamoyl groups having 0 to 30 carbon atoms such as N-ethylsulfamoyl, N-(3-dodecyloxypropyl)sulfamoyl, N,N-dimethylsulfamoyl, N-acetylsulfamoyl, N-benzoylsulfamoyl, N-(N′-phenylcarbamoyl) sulfamoyl), alkylsulfinyl groups and arylsulfinyl groups (preferably substituted or unsubstituted alkylsulfinyl groups having 1 to 30 carbon atoms, substituted or unsubstituted arylsulfinyl groups having 6 to 30 carbon atoms, such as methylsulfinyl, ethylsulfinyl, phenylsulfinyl, p-methylphenylsulfinyl), alkylsulfonyl groups and arylsulfonyl groups (preferably substituted or unsubstituted alkylsulfonyl groups having 1 to 30 carbon atoms, substituted or unsubstituted arylsulfonyl groups having 6 to 30 carbon atoms, such as methylsulfonyl, ethylsulfonyl, t-butylsulfonyl, s-butylsulfonyl, phenylsulfonyl, pyridylsulfonyl, p-methylphenylsulfonyl), acyl groups (preferably substituted or unsubstituted alkylcarbonyl groups having 2 to 30 carbon atoms, substituted or unsubstituted arylcarbonyl groups having 7 to 30 carbon atoms, substituted or unsubstituted heterocyclic carbonyl groups having 4 to 30 carbon atoms, whose carbonyl group is bonded via a carbon atom, such as acetyl, pivaloyl, 2-chloroacetyl, stearoyl, benzoyl, p-n-octyloxyphenylcarbonyl, 2-pyridylcarbonyl, 2-furylcarbonyl), aryloxycarbonyl groups (preferably substituted or unsubstituted aryloxycarbonyl groups having 7 to 30 carbon atoms such as phenoxycarbonyl, o-chlorophenoxycarbonyl, m-nitrophenoxycarbonyl, p-t-butylphenoxycarbonyl), alkoxycarbonyl groups (preferably substituted or unsubstituted alkoxycarbonyl groups having 2 to 30 carbon atoms such as methoxycarbonyl, ethoxycarbonyl, t-butoxycarbonyl, n-octadecyloxycarbonyl), carbamoyl groups (preferably substituted or unsubstituted carbamoyl having 1 to 30 carbon atoms such as carbamoyl, N-methylcarbamoyl, N,N-dimethylcarbamoyl, N,N-di-n-octylcarbamoyl, N-(methylsulfonyl)carbamoyl), and imide groups (preferably N-succinimide, N-phthalimide).

In the Formula (1), R¹ represents a substituent, which is preferably an alkyl group, an aryl group or a heterocyclic group, more preferably an alkyl group.

R² represents a hydrogen atom or a substituent, preferably a substituent, more preferably an alkyl group, an aryl group, a heterocyclic group, a hydroxyl group, an alkoxy group, an aryloxy group, a heterocyclic oxy group, an acylamino group, an alkylsulfonylamino group, an arylsulfonylamino group, a mercapto group, an alkylthio group, an arylthio group, a heterocyclic thio group or a carbamoyl group. R² is further preferably an alkoxy group, an aryloxy group, an acylamino group, an alkylsulfonylamino group, an arylsulfonylamino group, an alkylthio group, an arylthio group or a heterocyclic thio group, and particularly preferably an aryloxy group.

R³ represents a hydrogen atom or a substituent, which is preferably a hydrogen atom or an alkyl group.

M represents a hydrogen atom or a monovalent cation. Examples of monovalent cations include alkali metal atoms such as lithium, sodium and potassium, ammonium, quaternary ammonium, imidazolium, sulfonium, phosphonium and iodonium. Preferably, the monovalent cation is a hydrogen atom, a monovalent alkali metal atom or quaternary ammonium, more preferably a hydrogen atom, lithium, sodium or potassium.

Further, any one of R¹ to R³ preferably contains one or more heteroatoms.

A preferred form of the Formula (1) is a combination in which R¹, R², R³, n, L¹ and M are each an alkyl group, an aryloxy group, a hydrogen atom, 1, a single bond and a hydrogen atom.

Preferred examples of low molecular weight dispersants having a molecular weight of 2000 or lower represented by the Formula (1) include the following compounds (1-1) to (1-27).

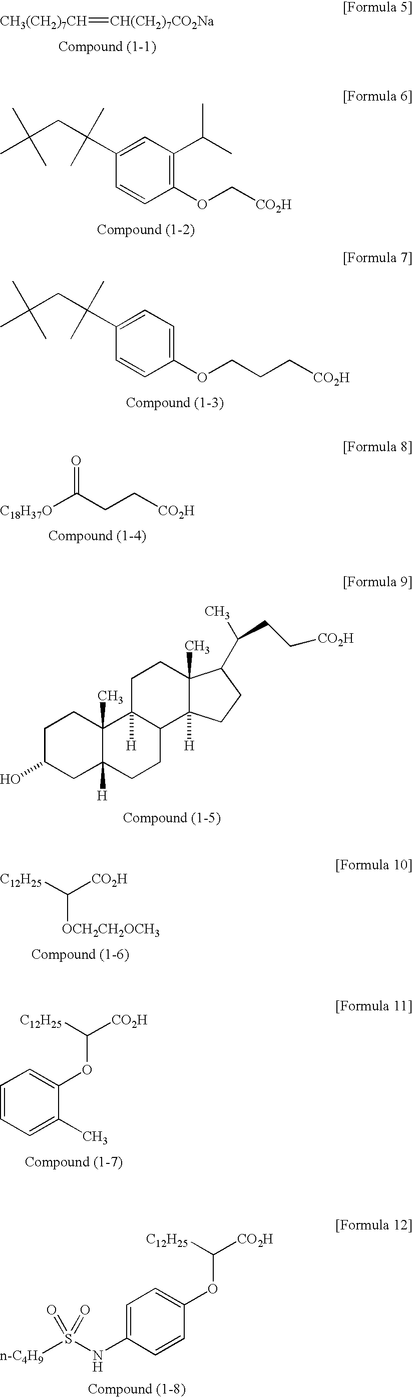

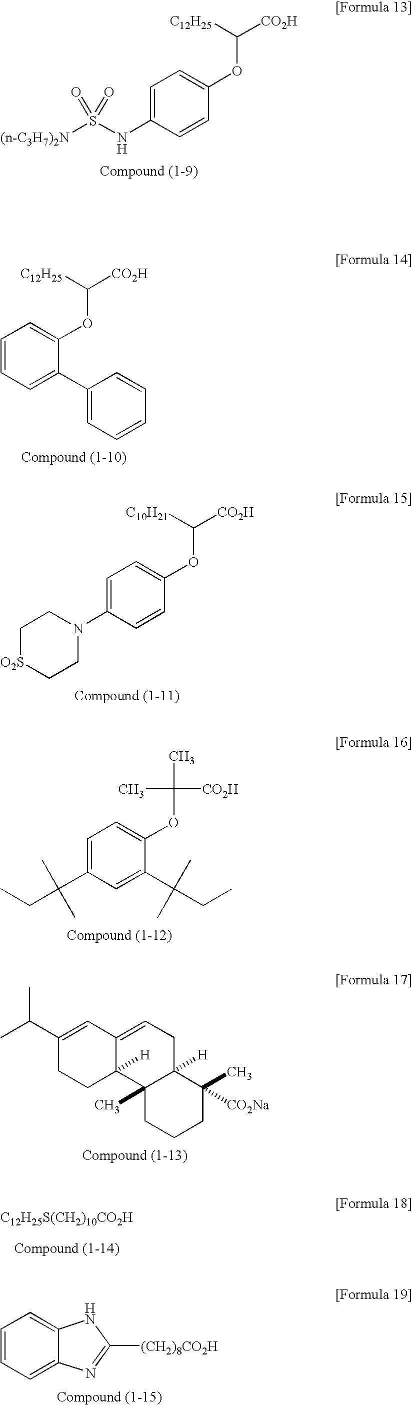

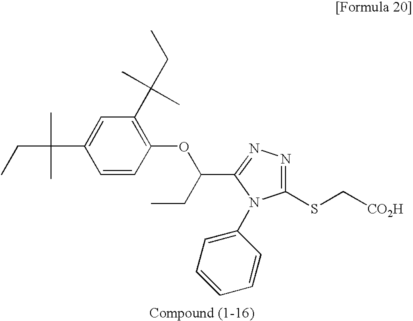

Compounds containing a substituent selected from the group of R¹, R² and R³ in Table 1 can also be preferably used.

[Table 1]

TABLE 1

| R¹ | R² | R³ |
|---|---|---|
| C₁₂H₂₅— | H— | H— |
| C₁₇H₃₅— | CH₃— | CH₃— |
| CH₃(CH₂)₇CH═CH(CH₂)₇— | C₆H₁₃— | 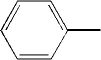 |
| 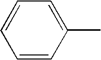 | HO— | 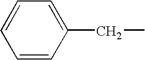 |
| 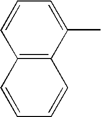 | C₈H₁₇O— | |
| 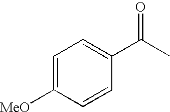 | 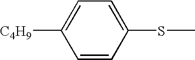 | |
| 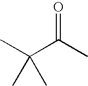 | 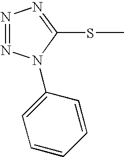 | |
| | 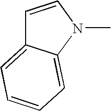 | |
| | 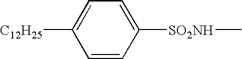 | |
| | HSCH₂— | |

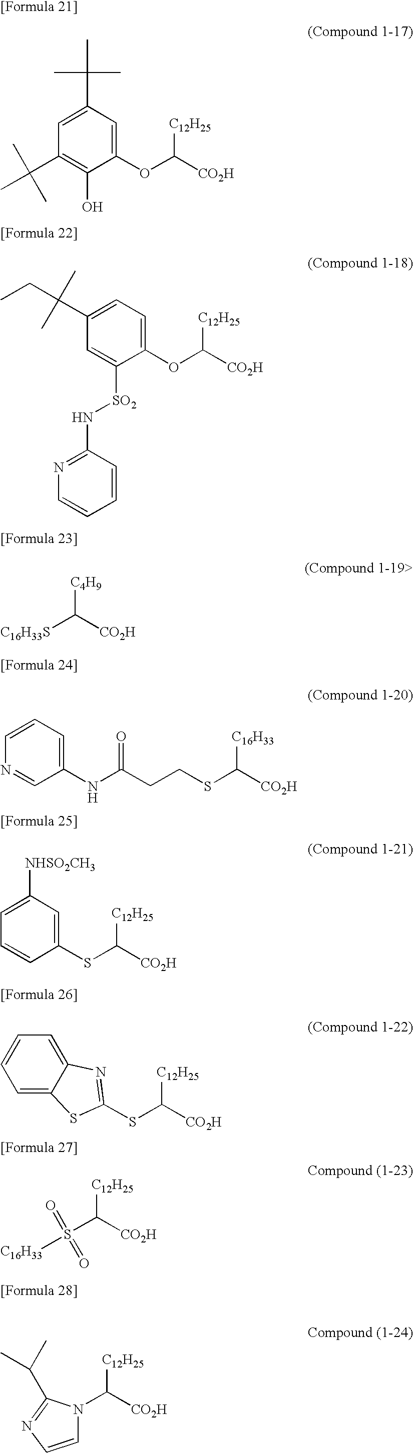

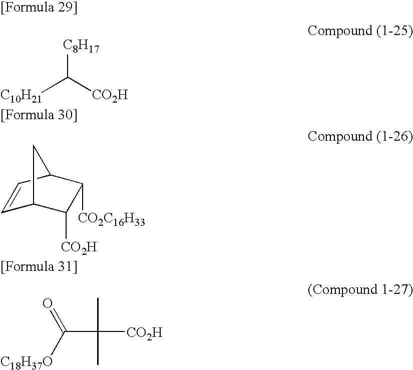

In addition, preferably the low molecular weight dispersant is a compound represented by the Formula (2) or (3), in which L¹ of the Formula (1) is an amide group.

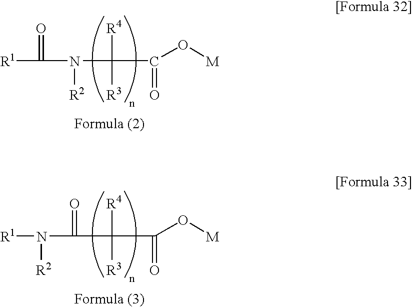

In the Formulas (2) and (3), R¹ represents a substituent, R², R³ and R⁴ each represent a hydrogen atom or a substituent. n represents an integer of 0 to 6. M represents a hydrogen atom or a monovalent cation, which is the same as M described above. R¹ to R⁴ do not contain a sulfonic acid group, and the sum of their carbon atoms is 13 or more (preferably 140 or less). Herein, the aforementioned substituent T can be used as the substituent.

In the Formulas (2) and (3), R¹ represents a substituent, which is preferably an alkyl group, an aryl group, a heterocyclic group, an alkoxy group, an aryloxy group, a heterocyclic oxy group, an amino group, more preferably an alkyl group, and most preferably an alkyl group having 12 or more carbon atoms.

R² represents a hydrogen atom or a substituent. Preferably, the substituent is an alkyl group, an aryl group, a heterocyclic group, an acyl group or a sulfonyl group, more preferably an alkyl group, further preferably an alkyl group having 4 or less carbon atoms. R² is particularly preferably a hydrogen atom or a methyl group.

R³ and R⁴ represent a hydrogen atom or a substituent, which is preferably a hydrogen atom or an alkyl group, more preferably a hydrogen atom.

The sum of carbon atoms in R¹ to R⁴ is preferably 13 to 140, more preferably 15 to 100.

A preferred form of the Formula (2) or (3) is a combination in which R¹, R², R³, R⁴, n and M are each an alkyl group, a methyl group, a hydrogen atom, a hydrogen atom, 2 and a hydrogen atom.

Preferred examples of low molecular weight dispersants having a molecular weight of 2000 or lower represented by the Formula (2) or (3) also include the following compounds (2-1) to (2-8) and compounds (3-1) to (3-6).

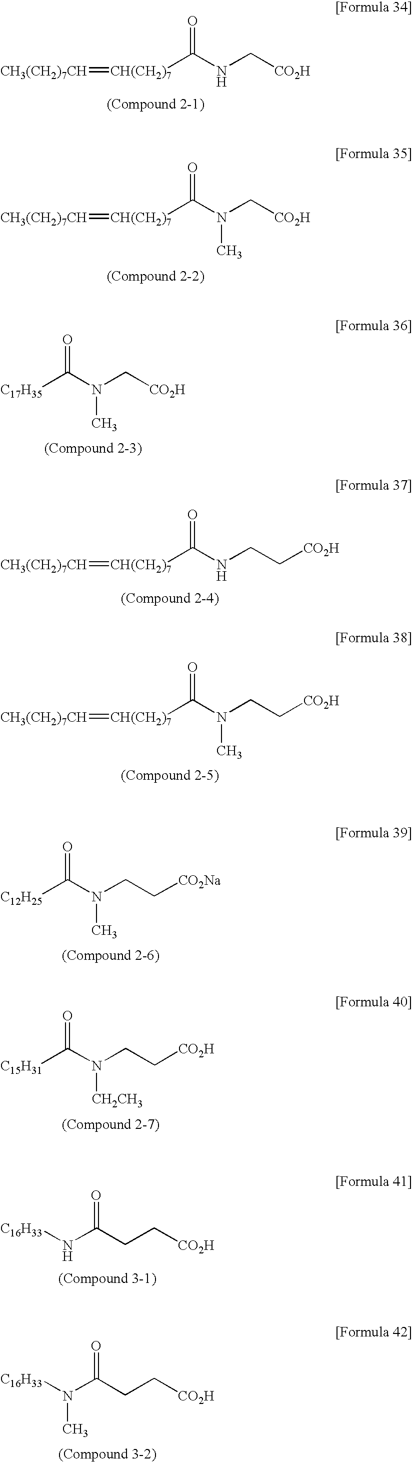

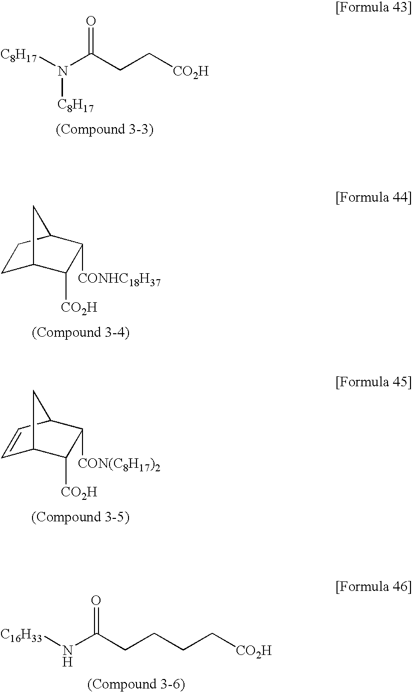

The molecular weight of the above compounds (1-1) to (1-27), (2-1) to (2-7) and (3-1) to (3-6) is shown in Table 2.

[Table 2]

TABLE 2

| | Molecular |
|---|---|
| Compound | weight |
| 1-1 | 304.4 |
| 1-2 | 306.4 |
| 1-3 | 292.4 |
| 1-4 | 370.6 |
| 1-5 | 376.57 |
| 1-6 | 302.5 |
| 1-7 | 334.5 |
| 1-8 | 455.7 |
| 1-9 | 498.7 |
| 1-10 | 396.6 |
| 1-11 | 425.6 |
| 1-12 | 320.5 |
| 1-13 | 324.4 |
| 1-14 | 386.7 |
| 1-15 | 274.4 |
| 1-16 | 509.3 |
| 1-17 | 448.7 |
| 1-18 | 547.8 |
| 1-19 | 372.7 |
| 1-20 | 464.7 |
| 1-21 | 429.6 |
| 1-22 | 393.6 |
| 1-23 | 516.9 |
| 1-24 | 336.5 |
| 1-25 | 312.5 |
| 1-26 | 406.6 |
| 1-27 | 384.6 |
| 2-1 | 339.5 |
| 2-2 | 353.5 |
| 2-3 | 355.6 |
| 2-4 | 353.5 |
| 2-5 | 367.6 |
| 2-6 | 321.4 |
| 2-7 | 355.6 |
| 3-1 | 341.5 |
| 3-2 | 355.6 |
| 3-3 | 341.5 |
| 3-4 | 435.7 |
| 3-5 | 405.6 |
| 3-6 | 369.6 |

(Polymer Fine Particles)

The polymer fine particles used in this embodiment are added to ink mainly to improve fixing properties of the ink to a recording medium and the scratch resistance of the coated surface. Polymer fine particles dispersed in water and a water-containing organic solvent as a polymer latex are preferred.

The polymer latex used in this embodiment is not particularly limited as long as it is composed of a polymer of a monomer compound containing an unsaturated double bond.

Examples of such monomers include aromatic vinyl compounds, acrylic acid and ester compounds and amide compounds thereof, methacrylic acid and ester compounds and amide compounds thereof, vinyl ester compounds, vinyl cyanide compounds, olefin compounds and diene compounds, and homopolymers or copolymers thereof may be used. More specific examples of such monomers include aromatic vinyl monomers such as styrene, 2-methylstyrene, vinyl toluene, t-butylstyrene, chlorostyrene, vinyl anisole and vinyl naphthalene; acrylic acid and acrylic esters such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, phenyl acrylate, benzyl acrylate, glycidyl acrylate and N,N-dimethylaminoethyl acrylate; acrylic amide compounds such as acrylamide, N,N-dimethylaminopropylacrylamide, N,N-dimethylacrylamide, acryloylmorpholine, N-isopropylacrylamide and N,N-diethylacrylamide; methacrylic acid and methacrylic esters such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate and glycidyl methacrylate; vinyl esters such as vinyl acetate; vinyl cyanide compounds such as acrylonitrile and methacrylonitrile; halogenated monomers such as vinylidene chloride and vinyl chloride; olefins such as ethylene, propylene and isopropylene; dienes such as butadiene, isoprene and chloroprene; and vinyl monomers such as vinyl ether, vinyl ketone and vinyl pyrrolidone. For stable dispersion of the latex, a monomer having a dissociable group, such as acrylic acid, methacrylic acid, itaconic acid, fumaric acid or maleic acid is more preferably contained.

Styrene latexes containing styrene as a constituent monomer, acrylic latexes containing acrylic ester as a constituent monomer and vinyl acetate latexes containing vinyl acetate as a constituent monomer are preferred as the polymer latex. Styrene latexes of a styrene-butadiene copolymer, a styrene-isoprene copolymer or a styrene-acrylic ester copolymer and acrylic latexes composed of acrylic ester are more preferred. Styrene latexes such as styrene-butadiene copolymer latexes, styrene-isoprene copolymer latexes and styrene-acrylic ester copolymer latexes are further preferred, and styrene-butadiene copolymer latexes are particularly preferred.

The mass ratio of the styrene monomer unit to the butadiene monomer unit in a styrene-butadiene copolymer is preferably 20:80 to 95:5, more preferably 30:70 to 80:20, further preferably 30:70 to 55:45.

Preferably, the styrene monomer unit and the butadiene monomer unit account for 60 to 99% by mass of the entire copolymer.

The polymer latex used in this embodiment may be those obtained by copolymerizing a monomer in addition to styrene and butadiene. Any monomer may be used as a monomer to be copolymerized as long as it is copolymerizable. Examples thereof include styrene containing a substituent (substituent T described before can be used as the substituent), acrylic acid, methacrylic acid and esters and amides thereof.

Such a polymer latex is preferably acrylic acid, methacrylic acid, acrylic ester, methacrylic acid ester, acrylamide-2-methylpropanesulfonic acid, more preferably acrylic acid, methacrylic acid and acrylamide-2-methylpropanesulfonic acid, further preferably acrylic acid and methacrylic acid.

The polymer latex contains preferably 1 to 6% by mass, more preferably 2 to 5% by mass of acrylic acid or methacrylic acid based on the total of styrene and butadiene. Preferably, these polymer latexes contain acrylic acid.

Examples of styrene-butadiene-acrylic acid copolymer latex suitably used in this embodiment include commercially available LACSTAR-3307B, 7132C (available from DAINIPPON INK AND CHEMICALS INCORPORATED), Nipol Lx416 (available from ZEON CORPORATION) and Nalstar SBR (available from NIPPON A&L INC.).

Styrene may contain a substituent, and the aforementioned substituent T can be used as the substituent.

When the amount to be added of the polymer fine particles in the ink is large, the effect of improving fixing properties and scratch resistance is great, but the viscosity of the ink rather increases. Accordingly, polymer fine particles are added to the ink in a proportion of preferably 0.5 to 20% by mass, more preferably 1 to 20% by mass, further preferably 3 to 20% by mass, even more preferably 5 to 15% by mass.

Thus, when it is necessary to further increase the amount of polymer fine particles, preferably the polymer fine particles are added to the treating liquid as well. The content of the fine particles in the treating liquid is the same as that in the ink.

The glass transition temperature Tg of the polymer fine particles used in this embodiment is calculated from the following formula.
1/Tg=Σ(Xi/Tgi) [Formula 1]

Herein, in polymer fine particles, n monomer components of i=1 to n are copolymerized. Xi is the weight fraction of the ith monomer (ΣXi=1) and Tgi is the glass transition temperature (absolute temperature) of a homopolymer of the ith monomer. Σ is the sum when i=1 to n. The glass transition temperature value (Tgi) of a homopolymer of each monomer is calculated with reference to values in Polymer Handbook (3rd Edition)(J. Brandrup, E. H. Immergut (Wiley-Interscience, 1989)) on condition that the glass transition temperature of a homopolymer of styrene is 100° C. and that of butadiene is −85° C. Accordingly, even if the kind of constituent monomers is the same, Tg can be controlled by changing the composition ratio of the monomers.

The polymer fine particles used in this embodiment have a glass transition temperature Tg of preferably room temperature or higher, i.e., 30° C. or higher in terms of the storage stability of ink. The glass transition temperature Tg is more preferably 40° C. or higher, further preferably 50° C. or higher. Although a high glass transition temperature Tg may cause a problem that the printed samples are sticky, such stickiness can be reduced by heating after printing even for polymer fine particles having a high glass transition temperature Tg.

The polymer fine particles have an average particle size of 10 nm to 1 μm, more preferably 10 to 500 nm, further preferably 20 to 200 nm, particularly preferably 50 to 200 nm. The particle size distribution of polymer fine particles is not particularly limited. Any polymer particles having a wide particle size distribution or monodisperse particle size distribution may be used. Two or more kinds of polymer fine particles having monodisperse particle size distribution may be used in a mixture.

(Organic Pigment)

The ink used in this embodiment can be used for forming not only monotone images but also full color images. To form full color images, magenta color ink, cyan color ink and yellow color ink can be used. For adjusting color tone, black color ink may be additionally used. In addition, so-called special color ink in the printing field other than yellow, magenta or cyan color ink, such as red, green, blue or white ink can be used.

Specific examples of pigments used in this embodiment are described below.

Examples of pigments for orange or yellow include C.I. pigment orange 31, C.I. pigment orange 43, C.I. pigment yellow 12, C.I. pigment yellow 13, C.I. pigment yellow 14, C.I. pigment yellow 15, C.I. pigment yellow 17, C.I. pigment yellow 74, C.I. pigment yellow 93, C.I. pigment yellow 94, C.I. pigment yellow 128, C.I. pigment yellow 138, C.I. pigment yellow 151, C.I. pigment yellow 155, C.I. pigment yellow 180 and C.I. pigment yellow 185.

Examples of pigments for magenta or red include C.I. pigment red 2, C.I. pigment red 3, C.I. pigment red 5, C.I. pigment red 6, C.I. pigment red 7, C.I. pigment red 15, C.I. pigment red 16, C.I. pigment red 48:1, C.I. pigment red 53:1, C.I. pigment red 57:1, C.I. pigment red 122, C.I. pigment red 123, C.I. pigment red 139, C.I. pigment red 144, C.I. pigment red 149, C.I. pigment red 166, C.I. pigment red 177, C.I. pigment red 178 and C.I. pigment red 222.

Examples of pigments for green or cyan include C.I. pigment blue 15, C.I. pigment blue 15:2, C.I. pigment blue 15:3, C.I. pigment blue 16, C.I. pigment blue 60, C.I. pigment green 7 and siloxane-bridged aluminum phthalocyanine described in U.S. Pat. No. 4,311,775.

Examples of pigments for black include C.I. pigment black 1, C.I. pigment black 6 and C.I. pigment black 7.

The smaller the average particle size of the organic pigment, the better, in terms of transparency and color reproducibility, whereas the larger the better in terms of light fastness. To meet both requirements, the average particle size is preferably 10 to 200 nm, more preferably 10 to 150 nm, further preferably 10 to 100 nm. The particle size distribution of the organic pigment is not particularly limited. Any organic pigment having a wide particle size distribution or monodisperse particle size distribution may be used. Two or more kinds of organic pigments having monodisperse particle size distribution may be used in a mixture.

The organic pigment is added to ink in a proportion of preferably 1 to 25% by mass, more preferably 2 to 20% by mass, further preferably 5 to 20% by mass, particularly preferably 5 to 15% by mass.

(Water-Soluble Organic Solvent)

The water-soluble organic solvent used in this embodiment is used for preventing dryness or providing humidity. A drying preventing agent is suitably used in the ink jet port of a nozzle in an inkjet recording system, preventing clogging due to drying of ink for inkjet.

Preferably, the drying preventing agent is a water-soluble organic solvent which has a vapor pressure lower than that of water. Specific examples of drying preventing agents include polyhydric alcohols such as ethylene glycol, propylene glycol, diethylene glycol, polyethylene glycol, thiodiglycol, dithiodiglycol, 2-methyl-1,3-propanediol, 1,2,6-hexanetriol, acetylene glycol derivatives, glycerol and trimethylolpropane, lower alkyl ethers of polyhydric alcohol such as ethylene glycol monomethyl (or ethyl) ether, diethylene glycol monomethyl (or ethyl) ether and triethylene glycol monoethyl (or butyl) ether, heterocycles such as 2-pyrrolidone, N-methyl-2-pyrrolidone, 1,3-dimethyl-2-imidazolidinone and N-ethylmorpholine, sulfur containing compounds such as sulfolane, dimethyl sulfoxide and 3-sulfolene, multifunctional compounds such as diacetone alcohol and diethanolamine and urea derivatives. Of these, a preferred drying preventing agent is polyhydric alcohol such as glycerol and diethylene glycol. The above drying preventing agent may be used alone or in a combination of two or more. The drying preventing agent is included in the ink in a proportion of 10 to 50% by mass.

A penetrating accelerant is suitably used for allowing ink to penetrate into a recording medium (printing paper) well. Specific examples of penetrating accelerants preferably used include alcohols such as ethanol, isopropanol, butanol, di(tri)ethylene glycol monobutyl ether and 1,2-hexanediol, sodium lauryl sulfate, sodium oleate and nonionic surfactants. These penetrating accelerants produce a sufficient effect when they are contained in the ink composition in a proportion of 5 to 30% by mass. Further, the penetrating accelerants is used within the range in which blurring of print or strike through (print through) is not caused.

The water-soluble organic solvent is used for adjusting viscosities other than the above purposes. Specific examples of water-soluble organic solvents which can be used for adjusting viscosities include alcohol (e.g., methanol, ethanol, propanol, isopropanol, butanol, isobutanol, sec-butanol, t-butanol, pentanol, hexanol, cyclohexanol, benzyl alcohol), polyhydric alcohols (e.g., ethylene glycol, diethylene glycol, triethylene glycol, polyethylene glycol, propylene glycol, dipropylene glycol, polypropylene glycol, butylene glycol, hexanediol, pentanediol, glycerol, hexanetriol, thiodiglycol), glycol derivatives (e.g., ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, ethylene glycol monophenyl ether), amines (e.g., ethanolainine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, tetramethylpropylenediamine) and other polar solvents (e.g., formamide, N,N-dimethylformamide, N,N-dimethylacetamide, dimethyl sulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, acetone). The water-soluble organic solvent may be used alone or in combination of two or more.

(Other Additives)

Examples of other additives used in this embodiment include known additives such as drying preventing agents (wetting agents), fading inhibitors, emulsification stabilizers, penetrating accelerants, ultraviolet absorbers, preservatives, fungicides, pH adjusters, surface tension adjusters, defoaming agents, viscosity adjusters, dispersants, dispersion stabilizers, rust preventives and chelating agents. These additives are directly added to ink when the ink is water-soluble. When using a dispersion of oil-soluble dye, an additive is generally added to the dispersion of dye after preparing such a dispersion. However, the additive may also be added to the oil phase or the aqueous phase upon preparation.

The ultraviolet absorber is used for improving storage properties of images. Useful as such a ultraviolet absorber are benzotriazole compounds described in Japanese Patent Application Laid-Open Nos. 58-185677, 61-190537, 2-782, 5-197075 and 9-34057, benzophenone compounds described in Japanese Patent Application Laid-Open Nos. 46-2784, 5-194483 and U.S. Pat. No. 3,214,463, cinnamic acid compounds described in Japanese Examined Application Publication Nos. 48-30492, 56-21141 and Japanese Patent Application Laid-Open No. 10-88106, triazine compounds described in Japanese Patent Application Laid-Open Nos. 4-298503, 8-53427, 8-239368, 10-182621 and National Publication of International Patent Application No. 1997-501291, compounds described in Research Disclosure No. 24239, and compounds which emit fluorescence upon absorption of ultraviolet light such as stilbene compounds and benzoxazole compounds, which are so-called fluorescent brightener.

A fading inhibitor is used for improving storage properties of images. Various organic or metal complex fading inhibitors can be used as such a fading inhibitor. Examples of organic fading inhibitors include hydroquinones, alkoxyphenols, dialkoxyphenols, phenols, anilines, amines, indans, chromans, alkoxy anilines and heterocycles. Examples of metal complexes include nickel complexes and zinc complexes. More specifically, compounds described in patents cited in Research Disclosure No. 17643, VII-I to J, No. 15162, No. 18716, p. 650, left column, No. 36544, p. 527, No. 307105, p. 872 and No. 15162, and compounds included in the formula of typical compounds and in examples of compounds described in Japanese Patent Application Laid-Open No. 62-215272, pp. 127 to 137 can be used.

Examples of fungicides include sodium dehydroacetate, sodium benzoate, sodium pyridinethione-1-oxide, ethyl p-hydroxybenzoate, 1,2-benzisothiazoline-3-one and salts thereof. These are used in a proportion of 0.02 to 1.00% by weight in ink.

A neutralizing agent (organic base, inorganic alkali) can be used as a pH adjuster. The pH adjuster is added in order to improve the storage stability of ink for inkjet so that the ink for inkjet has a pH of preferably 6 to 10, more preferably pH 7 to 10.

Examples of surface tension adjusters used in this embodiment include nonionic surfactants, cationic surfactants, anionic surfactants and betaine surfactants.

For good ejection in inkjet, the surface tension adjuster is added in such an amount that the surface tension of ink is adjusted to preferably 20 to 60 mN/m, more preferably 20 to 45 mN/m and further preferably 25 to 40 mN/m.

Specific examples of surfactants include, in the case of hydrocarbon surfactants, anionic surfactants such as fatty acid salt, alkylsulfate salt, alkylbenzene sulfonate, alkylnaphthalene sulfonate, dialkylsulfosuccinate, alkylphosphate salt, naphthalene sulfonic acid formalin condensate and polyoxyethylene alkylsulfate salt, and nonionic surfactants such as polyoxyethylene alkyl ether, polyoxyethylene alkyl allyl ether, polyoxyethylene fatty acid ester, sorbitan fatty acid ester, polyoxyethylene sorbitan fatty acid ester, polyoxyethylene alkylamine, glycerol fatty acid ester and oxyethylene oxypropylene block copolymers. In addition, SURFYNOLS (available from Air Products & Chemicals, Inc.) which is an acetylene polyoxyethylene oxide surfactant is preferably used. Further, amine oxide type amphoteric surfactants such as N,N-dimethyl-N-alkylamine oxide are preferred.

In addition, surfactants listed in Japanese Patent Application Laid-Open No. 59-157636, page (37) to (38) and Research Disclosure No. 308119 (1989) may be used.

Further, by using a fluorine (fluoroalkyl) surfactant or a silicone surfactant described in Japanese Patent Application Laid-Open Nos. 2003-322926, 2004-325707 and 2004-309806, scratch resistance can be improved.

These surface tension adjusters can also be used as a defoaming agent. Fluorine compounds, silicone compounds and chelating agents such as EDTA can also be used.

The treating liquid to be brought into contact with the above ink is now described in detail.

[Treating Liquid]

The treating liquid used in this embodiment is used with ink mainly for preventing blotting of the ink upon printing and for achieving high speed printing.

A treating liquid which produces an agglomerate when the pH of ink is changed is preferred as the treating liquid used in this embodiment. At this stage, the treating liquid has a pH of preferably 1 to 6, more preferably 2 to 5, further preferably 3 to 5. To make the treating liquid acidic, compounds having a furan, pyrrole, pyrroline, pyrrolidone, pyrrone, thiophene, indole, pyridine or quinoline structure and containing a carboxyl group as a functional group, such as pyrrolidonecarboxylic acid, pyronecarboxylic acid, pyrrolecarboxylic acid, furancarboxylic acid, pyridinecarboxylic acid, coumaric acid, thiophenecarboxylic acid, nicotinic acid, a derivative of these compounds, or a salt thereof is added to the treating liquid.

Preferably, the above compound is pyrrolidonecarboxylic acid, pyronecarboxylic acid, furancarboxylic acid, coumaric acid, a derivative of those compounds or a salt thereof. These compounds may be used alone or in a combination of two or more.

A flocculant may be added to the treating liquid instead of the above compounds. Examples of such flocculants include alkali metal ions such as lithium ions, sodium ions and potassium ions, multivalent metal ions such as aluminum ions, barium ions, calcium ions, copper ions, iron ions, magnesium ions, manganese ions, nickel ions, tin ions, titanium ions and zinc ions, hydrochloric acid, bromic acid, hydriodic acid, sulfuric acid, nitric acid, phosphoric acid, thiocyanic acid, organic carboxylic acid such as acetic acid, oxalic acid, lactic acid, fumaric acid, citric acid, salicylic acid and benzoic acid, and organic sulfonate.

The treating liquid used in this embodiment is not limited to the above compounds as long as the liquid allows the ink in which color material (organic pigment, etc) is dissolved and/or dispersed to flocculate. Specific examples of treating liquids include treating liquids which cause agglomeration by the change in the pH of ink (e.g., treating liquids described in Japanese Patent Application Laid-Open Nos. 7-1837 and 2004-359841), treating liquids which cause agglomeration by adding an inorganic salt to ink (e.g., treating liquids described in Japanese Patent Application Laid-Open Nos. 5-202328, 5-208548 and 9-29950), treating liquids which cause agglomeration upon reaction between anions and cations in a color material of ink which is charged and a compound which is oppositely charged (e.g., treating liquids described in Japanese Patent Publication Nos. 2667401, 3466756 and Japanese Patent Application Laid-Open Nos. 8-174997, 2001-199151), and treating liquids which cause agglomeration upon change in the composition of the solvent of the ink.

The treating liquid may also contain other additives as long as they do not destroy the advantages of the present invention. Examples of other additives include known additives such as drying preventing agents (wetting agents), fading inhibitors, emulsification stabilizers, penetrating accelerants, ultraviolet absorbers, preservatives, fungicides, pH adjusters, surface tension adjusters, defoaming agents, viscosity adjusters, dispersants, dispersion stabilizers, anti-corrosive agents and chelating agents. Namely, additives listed as specific examples of other additives contained in the ink (see item 5)) can be used. Further, by adding the above-described polymer fine particles to the treating liquid, the content of the polymer fine particles in the entire ink set can be increased.

[Inkjet Recording System]

In the following, recording paper and recording film used in inkjet printing using the ink set according to the present invention are described. The support of recording paper and recording film is composed of chemical pulp such as LBKP and NBKP, mechanical pulp such as GP, PGW, RMP, TMP, CTMP, CMP and CGP, or recycled pulp such as DIP. A support to which an additive such as a known pigment, binder, sizing agent, fixing agent, cationizing agent or paper strength additive is added according to need and which is manufactured using a Fourdrinier machine or a cylinder machine can be used. Other than such supports, any one of synthetic paper and plastic film sheet may be used. Preferably, the support has a thickness of 10 to 250 μm and a basis weight of 10 to 250 g/m². An ink receiving layer and a backcoat layer may be directly applied to the support, while the ink receiving layer and a backcoat layer may be applied after forming an anchor coat layer of starch or polyvinyl alcohol with a size press. The support may be further subjected to flattening treatment with a calender such as a machine calender, a TG calender or a soft calendar. In this embodiment, paper and plastic film to which polyolefin (e.g., polyethylene, polystyrene, polyethylene terephthalate, polybutene and copolymers thereof) is laminated on both faces is more preferably used as a support. Preferably, a white pigment (e.g., titanium oxide, zinc oxide) or a coloring dye (e.g., cobalt blue, ultramarine, neodymium oxide) is added to polyolefin.

The ink receiving layer formed on the support contains a pigment or an aqueous binder. The pigment is preferably a white pigment, and examples of white pigments include white inorganic pigments such as calcium carbonate, kaolin, talc, clay, diatomaceous earth, synthetic amorphous silica, aluminum silicate, magnesium silicate, calcium silicate, aluminum hydroxide, alumina, lithopone, zeolite, barium sulfate, calcium sulfate, titanium dioxide, zinc sulfide and zinc carbonate and organic pigments such as styrene pigments, acrylic pigments, urea resin and melamine resin. A porous inorganic pigment is preferred as a white pigment contained in the ink receiving layer, and synthetic amorphous silica having a large pore area is particularly preferred. Both silicic acid anhydride produced by a dry method and hydrous silicic acid produced by a wet method can be used as synthetic amorphous silica, but using hydrous silicic acid is particularly desired.

Examples of aqueous binder contained in the ink receiving layer include water-soluble polymers such as polyvinyl alcohol, silanol modified polyvinyl alcohol, starch, cationized starch, casein, gelatin, carboxymethyl cellulose, hydroxyethyl cellulose, polyvinyl pyrrolidone, polyalkylene oxide and polyalkylene oxide derivatives, and water dispersible polymers such as styrene-butadiene latex and acrylic emulsion. These aqueous binders may be used alone or in a combination of two or more. Of these, polyvinyl alcohol and silanol modified polyvinyl alcohol are particularly preferred in this embodiment in view of adherence to pigment and stripping properties of the ink receiving layer. The ink receiving layer may also contain a dye mordant, a water-proofing agent, a light fastness improver, a surfactant or other additives in addition to the pigment and the aqueous binder.

Preferably, the dye mordant added to the ink receiving layer is immobilized. To this end, a polymer dye mordant is preferably used. Such a polymer dye mordant is described in Japanese Patent Application Laid-Open Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134 and 1-161236, U.S. Pat. Nos. 2,484,430, 2,548,564, 3,148,061, 3,309,690, 4,115,124, 4,124,386, 4,193,800, 4,273,853, 4,282,305 and 4,450,224. The image receiving material containing a polymer dye mordant described on pp. 212 to 215 of Japanese Patent Application Laid-Open No. 1-161236 is particularly preferred. When the polymer dye mordant described in this publication is used, high quality images can be obtained and the light fastness of images is improved.

A water-proofing agent is effective for making images water resistant. For such a water-proofing agent, cationic resin is particularly desired. Examples of such cation resins include polyamide polyamine epichlorohydrin, polyethyleneimine, polyaminesulfone, dimethyl diallyl ammonium chloride polymer, cationic polyacrylamide and colloidal silica. Of these cationic resins, polyamide polyamine epichlorohydrin is particularly preferred. The content of these cation resins is preferably 1 to 15% by mass, more preferably 3 to 10% by mass based on the total of solid components in the ink receiving layer.

Examples of light fastness improvers include zinc sulfate, zinc oxide, a hindered amine antioxidant and a benzophenone or benzotriazole ultraviolet absorber. Of these, zinc sulfate is particularly preferred.

A surfactant functions as a coating auxiliary, a releasability improver, a slipping improver or an anti-static agent. Such a surfactant is described in Japanese Patent Application Laid-Open Nos. 62-173463 and 62-183457. An organic fluoro compound may be used instead of the surfactant. Preferably, the organic fluoro compound is hydrophobic. Examples of organic fluoro compounds include fluorine surfactants, oily fluorine compounds (e.g., fluorine oil) and solid fluorine compound resins (e.g., tetrafluoroethylene resin). Such organic fluoro compounds are described in Japanese Examined Application Publication No. 57-9053 (columns 8 to 17), Japanese Patent Application Laid-Open Nos. 61-20994, 62-135826, 2003-322926, 2004-325707 and 2004-309806. Examples of other additives added to the ink receiving layer include pigment dispersants, thickeners, defoaming agents, dyes, fluorescent brighteners, preservatives, pH adjusters, matting agents and hardening agents. One or more ink receiving layer may be provided.

A backcoat layer may be provided on the recording paper and recording film. Components that can be added to the layer include white pigments, aqueous binders and other components. Examples of white pigments contained in the backcoat layer include white inorganic pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudoboehmite, aluminum hydroxide, alumina, lithopone, zeolite, hydrated halloysite, magnesium carbonate and magnesium hydroxide and organic pigments such as styrene plastic pigments, acrylic plastic pigments, polyethylene, microcapsules, urea resins and melamine resins.

Examples of aqueous binders contained in the backcoat layer include water-soluble polymers such as styrene/maleate copolymers, styrene/acrylate copolymers, polyvinyl alcohol, silanol modified polyvinyl alcohol, starch, cationized starch, casein, gelatin, carboxymethyl cellulose, hydroxyethyl cellulose and polyvinylpyrrolidone and water dispersible polymers such as styrene-butadiene latex and acrylic emulsion. Other components contained in the backcoat layer include defoaming agents, foam inhibitors, dyes, fluorescent brighteners, preservatives and water-proofing agents.

A polymer latex may be added to layers constituting inkjet recording paper and recording film (including a backcoat layer). The polymer latex is used to improve properties of film such as dimentional stability, prevention of curl, prevention of adhesion and prevention of cracking in the film. Such a polymer latex is described in Japanese Patent Application Laid-Open Nos. 62-245258, 62-1316648 and 62-110066. When a polymer latex having a low glass transition temperature (40° C. or lower) is added to a layer containing a dye mordant, cracking and curl in the layer can be prevented. Further, curl can also be prevented by adding a polymer latex having a high glass transition temperature to a backcoat layer.

The ink and the ink set according to the present invention are used in not only inkjet recording systems, but also known systems such as a charge control system in which ink is discharged utilizing electrostatic attraction, a drop-on-demand system (pressure pulse system) utilizing vibration pressure of a piezoelectric element, an acoustic inkjet system in which electric signals are changed to acoustic beams and ink is irradiated with the beams, thereby discharging the ink utilizing the radiation pressure, and a thermal inkjet system in which pressure generated upon heating of ink to form bubbles is used. Inkjet recording systems also include a system of ejecting ink called photo-ink having a low concentration in a small volume in a large amount, a system in which image quality is improved by using a plurality of inks having substantially the same hue but different concentration, and a system in which transparent and colorless ink is used.

[Entire Structure of Inkjet Recording Apparatus]

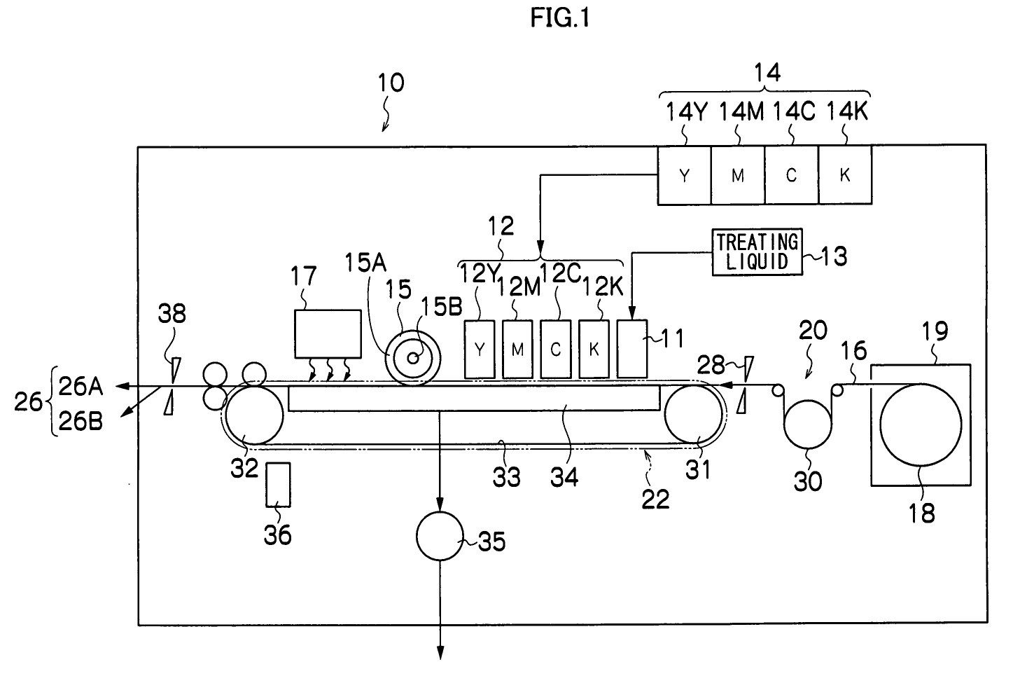

FIG. 1 is an entire structural view of an inkjet recording apparatus which is an embodiment of an apparatus for forming an image. As the figure shows, the inkjet recording apparatus 10 has a head for a treating liquid (corresponding to a treating liquid application device) 11 for discharging a treating liquid, a printing unit 12 composed of a plurality of printing heads (corresponding to ink discharge devices) 12K, 12C, 12M, 12Y provided corresponding to each color for discharging ink of each color of black (K), cyan (C), magenta (M) and yellow (Y), a treating liquid storing/loading unit 13 which stores a treating liquid fed to the head 11 for a treating liquid, an ink storing/loading unit 14 which stores color ink fed to the respective printing heads 12K, 12C, 12M, 12Y, a solvent absorbing roller (corresponding to a solvent absorbing device) 15 provided after the printing unit 12, a medium feeding unit 18 which feeds recording medium 16, a decurling unit 20 which removes curl of the recording medium 16, a suction belt carrying unit (corresponding to a carrying device) 22 provided against the nozzle faces (liquid discharge faces) of the head 11 for a treating liquid and the printing unit 12, which carries the recording medium 16 with keeping the recording medium 16 flat, and a delivering unit 26 which delivers the recorded recording medium 16 (printed matter) to the outside.

For the feeding system of the recording medium 16, a magazine 19 for roll paper (continuous paper) is described in FIG. 1 as an example of a medium feeding unit 18. However, a plurality of magazines for different paper widths or paper quality may also be provided. Alternatively, instead of or in addition to such a magazine for roll paper, paper may be fed through a cassette in which cut sheets are stacked and stored.

When a configuration allows use of plural kinds of recording media, preferably an information recorder such as a barcode or a radio tag on which the kind of the recording medium is recorded is attached to the magazine, and the data in the information recorder is read by a certain reader to automatically recognize the kind of the recording medium used (the media kind), and discharge control is performed so as to discharge the treating liquid and the ink appropriately according to the media kind.

The recording medium 16 sent out from the medium feeding unit 18 curls as the curl when stored in the magazine 19 remains. To remove such curl, heat is applied to the recording medium 16 at the decurling unit 20 from a heating drum 30 in the direction opposite from the curl direction in the magazine. At this stage, it is more preferable to control the heating temperature so that the print face is slightly curled outward.

In an apparatus configuration using roll paper, a cutter for cutting (the first cutter) 28 is provided as in FIG. 1. The roll paper is cut by the cutter 28 into a desired size. When cut sheets are used, the cutter 28 is not needed.

After decurling, the recording medium 16 that has been cut is transferred to the suction belt carrying unit 22. The suction belt carrying unit 22 has a structure in which an endless belt 33 is wound over rollers 31, 32 and is designed so that the part facing the nozzle face of at least the printing unit 12 is horizontal (flat).

The belt 33 is wider than the recording medium 16 and numerous suction holes (not shown) are formed on the belt surface. A suction chamber 34 is provided inside the belt wound over the rollers 31, 32 at a position against the nozzle face of the printing unit 12. By sucking in the suction chamber 34 with a fan 35 to create a negative pressure, the recording medium 16 is held on the belt 33 by the suction.

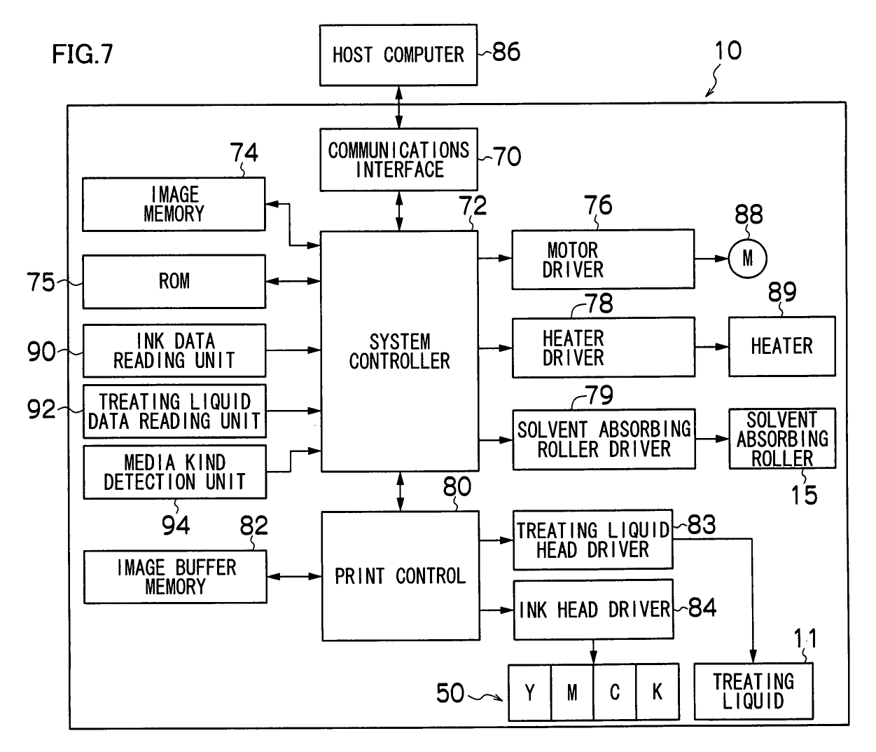

When power from a motor (reference numeral 88 in FIG. 7) is transmitted to at least one roller of the rollers 31, 32 on which the belt 33 is wound, the belt 33 is driven counterclockwise in FIG. 1 and the recording medium 16 held on the belt 33 is transferred from right to left in FIG. 1.

While an embodiment using a roller/nip carrying mechanism instead of the suction belt carrying unit 22 is also possible, such a mechanism has a problem that when such roller/nip carrying is performed in the printing region, the roller comes into contact with the printed face immediately after printing, and so images are easily blurred. Accordingly, suction belt carrying without making contact with image surfaces at printing regions as in this embodiment is preferred. The method of suction is not limited to suction (vacuum suction) described above, and electrostatic suction may also be used.

Since ink attaches to the belt 33 as well when frameless printing or the like is performed, a belt cleaning unit 36 is provided at a pre-determined position (an appropriate position other than the printing region) outside the belt 33. While no specific structure of the belt cleaning unit 36 is described in the figure, a system of nipping with a brush roll or a water absorbing roll, an air blow system in which clean air is sprayed, or a combination thereof is available. In the system of nipping with cleaning rolls, the cleaning effect is greater when the belt linear velocity and the roller linear velocity are different.

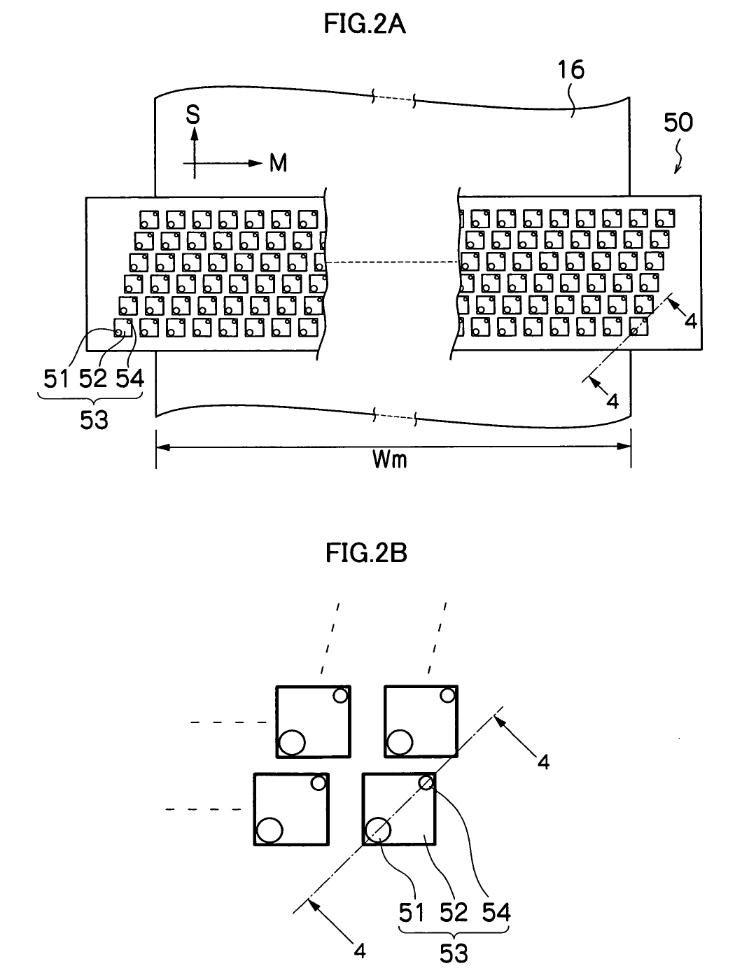

The head 11 for a treating liquid and the printing heads 12K, 12C, 12M, 12Y have a length corresponding to the maximum paper width of the recording medium 16 intended in the inkjet recording apparatus 10 (see FIGS. 2A and 2B). Nozzles for discharging ink or nozzles for discharging a treating liquid are disposed at the nozzle face over the length longer than at least one side of the largest recording medium (full width along the printable area), constituting full-line heads.

As shown in FIG. 1, printing heads 12K, 12C, 12M, 12Y are disposed in the color order of black (K), cyan (C), magenta (M), yellow (Y) from the upstream along the feed direction of the recording medium 16. The head 11 for a treating liquid is disposed on the upper stream of the printing unit 12. The respective heads 11, 12K, 12C, 12M, 12Y are fixed so as to extend along a direction substantially perpendicular to the traveling direction of the recording medium 16.

Such head arrangement allows the treating liquid to be applied to a recording face (a face to be printed) of the recording medium 16 through the head 11 for a treating liquid before ejecting ink of each color through the printing unit 12. Further, by discharging ink of different colors through the printing heads 12K, 12C, 12M, 12Y to the recording medium 16 to which the treating liquid is applied with carrying the recording medium 16 by the suction belt carrying unit 22, color images can be formed on the recording medium 16. In this step, the treating liquid previously ejected to the recording medium 16 and the ink subsequently ejected to the recording medium 16 react on the recording medium 16 to form an agglomerate.

As described above, due to such a configuration composed of a head 11 for a treating liquid and printing heads 12K, 12C, 12M, 12Y of a full-line type which have a nozzle arrangement covering the full width of the paper, images can be recorded on the entire face of the recording medium 16 only by performing one operation of relatively moving the recording medium 16 and the printing unit 12 in the paper feeding direction (vertical scanning direction)(namely, by one vertical scanning). This makes high speed printing possible and improves productivity compared to the case of using shuttle heads where the recording head reciprocates in the direction perpendicular to the paper feed direction.

While this embodiment illustrates a configuration of standard colors KCMY (four colors), the color or the number of combination of ink is not limited thereto. Light ink, dark ink or special color ink may be additionally used according to need. For example, a configuration in which a printing head which discharges light ink such as light cyan or light magenta is added is also possible. Further, the order of arranging heads of the respective colors is not particularly limited.

The treating liquid storing/loading unit 13 has a treating liquid tank for storing a treating liquid, which is communicated to the head 11 for a treating liquid via an appropriate conduit. The treating liquid fed from the treating liquid tank is discharged through the head 11 for a treating liquid in droplets. The treating liquid storing/loading unit 13 has a detection device which indicates the remaining amount of the treating liquid (a display device, a warning beep generator) when the amount is small.

The ink storing/loading unit 14 has ink tanks 14K, 14C, 14M, 14Y which store ink corresponding to each printing head 12K, 12C, 12M, 12Y. The respective tanks are communicated to the printing heads 12K, 12C, 12M, 12Y via an unrepresented conduit. The ink storing/loading unit 14 has a detection device which indicates the remaining amount of the ink (a display device, a warning beep generator) when the amount is small and a mechanism for preventing improper charge of colors.

The surface of a solvent absorbing roller 15 is composed of a porous member 15A and the roller has a length corresponding to the maximum width of the recording medium 16 intended in the inkjet recording apparatus 10. The rotational axis 15B of the solvent absorbing roller 15 is positioned along the direction perpendicular to the traveling direction of the recording medium 16 (main scanning direction). The solvent absorbing roller 15 rotatably held with the rotational axis 15B as the center can rotate according to the traveling speed of the recording medium 16 so that the relative speed with respect to the recording medium 16 is 0, preventing disturbance of images due to rubbing of ink.

The solvent absorbing roller 15 may have a length corresponding to the full width of the recording medium 16 with one (single) long roller member, or the required length may be achieved by a plurality of roller modules divided and arranged along the direction substantially perpendicular to the traveling direction of the recording medium 16 (main scanning direction). Also, a configuration in which plural rows of solvent absorbing rollers are disposed along the traveling direction of the recording medium 16 is applicable.

Although not shown in FIG. 1, a vertical motion mechanism for moving the solvent absorbing roller 15 up and down relative to the recording medium 16 is provided. By adjusting the position of the solvent absorbing roller 15 (a relative position in the direction perpendicular to the recording face of the recording medium 16) by controlling the vertical motion mechanism based on the instruction from a system controller described later, the contact pressure with the recording medium 16 or the clearance between the recording medium 16 can be changed. In a configuration having a plurality of roller modules, an embodiment in which a mechanism for controlling the vertical position of each roller module is provided is preferred.

By transferring the recording medium 16 in the traveling direction with bringing the solvent absorbing roller 15 into contact with the ink on the recording medium 16, the solvent on the recording medium 16 (solvent separated from the color material) is absorbed to the solvent absorbing roller 15 due to the capillary attraction of the porous member 15A. Thus, the ink from which excess solvent is removed by the solvent absorbing roller 15 has an increased binding force of color materials, and then is fixed to the recording medium 16.

The solvent absorbing roller 15 composed of a porous member 15A is used as a device for absorbing and removing the solvent in this embodiment, but the form of the solvent absorbing device is not limited to rollers, and the device may also be in the form of a belt.

Further, a heating unit 17 is provided at the downstream of the solvent absorbing roller 15 which absorbs and removes a main solvent. In the heating unit 17, hot air heated to a pre-determined temperature of about 30° C. or higher is directly applied to the recording medium 16 to further evaporate the solvent remaining in the agglomerate on the recording medium 16. Upon this, polymer fine particles in the agglomerate are dried and cured. As a result, the color material is fixed to the recording medium 16 in the form of a film and printing excellent in scratch resistance, water resistance and fixing properties can be performed.

Although an example of fixing a color material by a method of directly applying hot air to an agglomerate on the recording medium 16 is shown in this embodiment as a method of heating an agglomerate, the method is not limited thereto. For example, a method of applying heat by a heater may also be used. Further, although the heating unit 17 is disposed at the downstream of the solvent absorbing roller 15 in this embodiment, the position is not limited thereto. The heating unit 17 may also be disposed at the upstream of the solvent absorbing roller 15 as long as heating can be performed after an agglomerate is formed.

The printed matter thus produced (product produced by printing) is delivered from the delivering unit 26. Preferably, proper images (print of intended images) and test printing are separately delivered. In the inkjet recording apparatus 10, an unrepresented sorting device is provided which changes the delivery route so as to sort printed matters of proper image and printed matters of test printing and send them to the respective delivery parts 26A, 26B.

When proper images and test printing are simultaneously formed side by side on a large sheet, the test printing portion is separated using a cutter (the second cutter) 38. The cutter 38 is disposed just before the delivering unit 26 and separates proper images from test printing portions when the test printing is performed on the image margin portion.

[Structure of Printing Head]

Now the structure of the printing head is described. Since printing heads 12K, 12C, 12M, 12Y of each color has a common structure, reference numeral 50 is used to represent the printing heads.

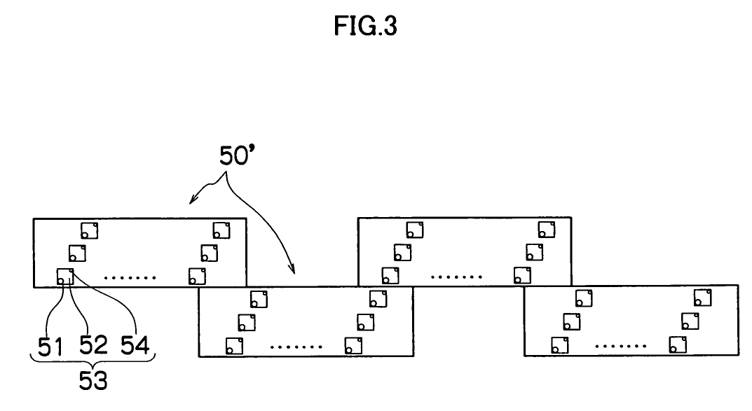

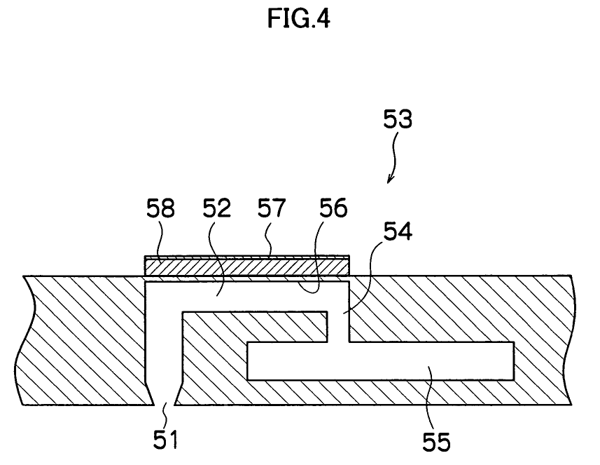

FIG. 2A is a perspective plan view illustrating an example of a structure of a printing head 50. FIG. 2B is an enlarged view of part thereof. FIG. 3 is a perspective plan view illustrating another example of a structure of a printing head 50. FIG. 4 is a cross sectional view illustrating a steric structure of a droplet discharge element (ink chamber unit corresponding to a nozzle 51)(a cross sectional view taken on line 4-4 in FIGS. 2A and 2B).

To increase the density of dot pitch upon printing on the recording medium 16, the density of nozzle pitch in the printing head 50 needs to be increased. The printing head 50 in this example has a structure in which ink chamber units (droplet discharge elements) 53 composed of a nozzle 51 which is an outlet of ink droplets and a pressure chamber 52 corresponding to the nozzle 51 are disposed in a zigzag pattern in a matrix form (two-dimensionally) as shown in FIGS. 2A and 2B. High density of actual nozzle interval (projected nozzle pitch) projected in such a manner to align in the head longitudinal direction (perpendicular to the paper feed direction) is achieved with this structure.

The mode for forming a nozzle line longer than the full width Wm of the recording medium 16 in the direction (the direction of arrow M; main scanning direction) perpendicular to the feed direction of the recording medium 16 (the direction of arrow S; vertical scanning direction) is not limited to the above example. For example, instead of the structure of FIG. 2A, preferably short head modules 50′ in which a plurality of nozzles 51 are two-dimensionally disposed are arranged and connected in a zigzag pattern to constitute a line head having a nozzle line having a length corresponding to the full width of the recording medium 16 as shown in FIG. 3. This is because such a line head makes high speed printing possible.

The pressure chamber 52 disposed corresponding to each nozzle 51 has a substantially square plane (see FIGS. 2A and 2B). An outlet for a nozzle 51 and an inlet (feed opening) 54 for supplied ink are diagonally provided at corners. The shape of the pressure chamber 52 is not limited to that in this example, and various shapes are available for the plane, such as quadrangles (diamonds, rectangles), pentagons, hexagons, other polygons, circles, and ellipses.

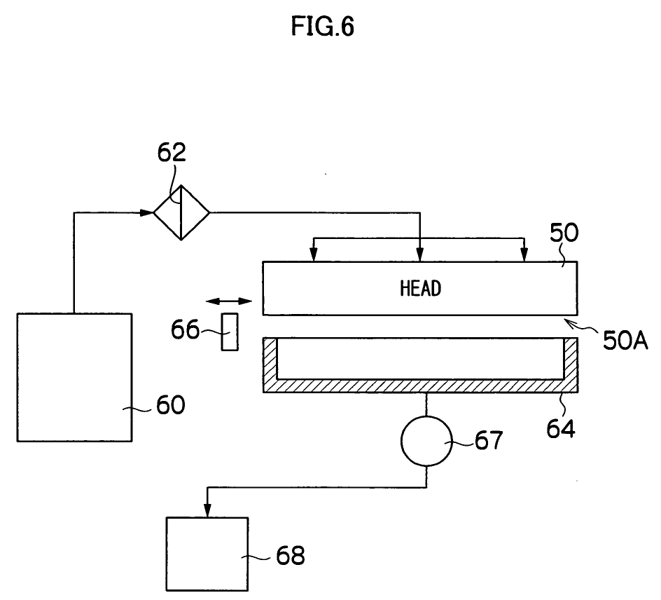

As shown in FIG. 4, each pressure chamber 52 is communicated to a common channel 55 via the feed opening 54. The common channel 55 is communicated to an ink tank which is a resource for supplying ink (not shown in FIG. 4, represented by reference numeral 60 in FIG. 6). The ink fed from the ink tank 60 is delivered to the respective pressure chambers 52 through the common channel 55 in FIG. 4.

An actuator 58 having an individual electrode 57 is connected to a pressure plate (a diaphragm used also as a common electrode) 56 constituting part (the top face in FIG. 4) of the pressure chamber 52. When drive voltage is applied between the individual electrode 57 and the common electrode, the actuator 58 transforms and the volume of the pressure chamber 52 changes, and due to the consequent pressure change, ink is discharged from the nozzle 51. A piezo-electric element using a piezo-electric body such as lead zirconium titanate or barium titanate is preferably used for the actuator 58. After discharging ink, fresh ink is supplied to the pressure chamber 52 through the feed opening 54 from the common channel 55 when the change in the actuator 58 is restored.

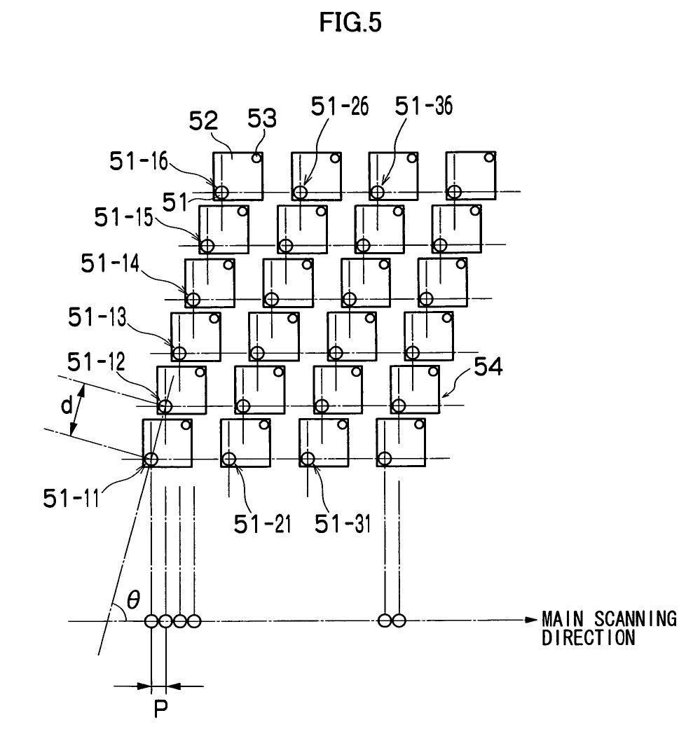

By disposing a great number of ink chamber units 53 with the above structure in a given arrangement pattern like a lattice in the line direction along the main scanning direction and in the diagonal row direction not perpendicular to the main scanning direction at a pre-determined angle of θ as shown in FIG. 5, the high density nozzle head of this embodiment is achieved.

Specifically, due to the structure in which ink chamber units 53 are disposed at a regular pitch d along a direction forming an angle θ relative to the main scanning direction, the pitch P of nozzles projected so as to align in the main scanning direction is d×cos θ. Thus, in the main scanning direction, the structure is equivalent to a structure in which nozzles 51 are linearly aligned at a given pitch P. Such a configuration makes a high density nozzle line possible.

When nozzles are driven with a full-line head having a nozzle line with a length corresponding to the full width of the printable width, (1) all nozzles are simultaneously driven, (2) nozzles are driven sequentially from one end to the other, or (3) nozzles are separated into block and driven sequentially per block from one end to the other. The drive of nozzles which prints a line (a line consisting of a line of dots or a line consisting of plural lines of dots) in the direction of the width of paper (the direction perpendicular to the traveling direction of paper) is defined as main scanning.

In particular, when driving nozzles 51 arranged in a matrix as shown in FIG. 5, the main scanning as in the above (3) is preferred. Specifically, nozzles 51-11, 51-12, 51-13, 51-14, 51-15, 51-16 form a block (also nozzles 51-21, . . . , 51-26 form a block, nozzles 51-31, . . . , 51-36 form a block), the nozzles 51-11, 51-12, . . . , 51-16 are sequentially driven according to the traveling speed of the recording medium 16 to print a line in the width direction of the recording medium 16.

On the other hand, repeating printing of a line (a line consisting of a line of dots or a line consisting of plural lines of dots) formed by the above-described main scanning by relatively moving the above-described full-line head and paper is defined as vertical scanning.

The direction shown by a line recorded by the above-described main scanning (or the longitudinal direction of the strip-shaped area) is called the main scanning direction, and the above-described direction for vertical scanning is called the vertical scanning direction. In short, in this embodiment, the traveling direction of the recording medium 16 corresponds to the vertical scanning and the direction perpendicular thereto corresponds to the main scanning direction.

In the practice of the present invention, the arrangement of nozzles is not limited to the example shown in the figures. Further, although this embodiment employs a method of delivering ink droplets by transformation of an actuator 58 such as a piezo element (piezo-electric element), the method of discharging ink is not particularly limited in the practice of the present invention. Instead of the piezo-jet method, various methods including a thermal jet method in which ink is heated by a heating element such as a heater to generate bubbles and shoot ink droplets by the pressure can be applied.

The structure of the head 11 for a treating liquid is not shown, but is more or less the same as that of the printing head 50 described above. However, since the treating liquid is substantially entirely (substantially uniformly) applied to some regions of the recording medium 16 where ink is ejected, high density dot formation is not required as in the case of applying ink. Accordingly, the head 11 for a treating liquid may have a structure having a smaller number of nozzles (a lower nozzle density) as compared to the head 50 for discharging ink. Further, a structure in which the nozzle diameter of the head 11 for a treating liquid is larger than the nozzle diameter of the printing head 50 for discharging ink is also possible.

[Configuration of Ink Feeding System]

FIG. 6 is a schematic view illustrating a configuration of an ink feeding system in the inkjet recording apparatus 10. The ink tank 60 is a base tank for supplying ink to a printing head 50, which is disposed in the ink storing/loading unit 14 shown in FIG. 1. In other words, the ink tank 60 in FIG. 6 is equivalent to the ink storing/loading unit 14 in FIG. 1. Configurations of the ink tank 60 include a system for supplying ink through an unrepresented supply port when the remaining amount of ink is small and a cartridge system for exchanging the tank itself when the remaining amount of ink is small. When the kind of ink is changed depending on the purpose of use, the cartridge system is preferred. In this case, preferably the data of the kind of ink is identified by a barcode or other means and discharge control is performed according to the kind of ink.

As shown in FIG. 6, a filter 62 for removing contaminants or bubbles is provided between the ink tank 60 and the printing head 50. Preferably, the mesh size of the filter is equal to or smaller than the nozzle diameter. Although not shown in FIG. 6, a configuration in which a sub tank is provided near the printing head 50 or integrally with the printing head 50 is also preferred. The sub tank has a damper effect for preventing fluctuation of internal pressure of the head and has a function to improve refilling.

Further, the inkjet recording apparatus 10 has a cap 64 which is a device for preventing drying of the nozzle 51 or preventing increase in the ink viscosity near the nozzle, and a cleaning blade 66 which is a device for cleaning the nozzle face 50A. A maintenance unit (recovery device) including the cap 64 and the cleaning blade 66 is movable relative to the printing head 50 by an unrepresented moving mechanism. Where necessary, the unit is moved to the maintenance position below the printing head 50 from a pre-determined retracting position.

The cap 64 is moved up and down relative to the printing head 50 by an unrepresented elevating mechanism. When the power is off or waiting for printing, the cap 64 is raised to a pre-determined elevated position and brought into close contact with the printing head 50 to cover the nozzle face 50A with the cap 64.

The cleaning blade 66 is made of an elastic material such as rubber and slidable against the nozzle face 50A (the surface of the nozzle plate) of the printing head 50 by an unrepresented blade moving mechanism. When ink droplets or contaminants attach to the surface of the nozzle plate, the cleaning blade 66 slides against the nozzle plate to wipe the surface of the nozzle plate.

When the frequency of use of a specific nozzle is low and the ink viscosity near the nozzle is increased during printing or standby, preliminary discharged to the cap 64 (serving also as an ink receiver) is performed to remove deteriorated ink.

In the printing head 50, when no discharge continues for a moment, the solvent of ink near the nozzle evaporates and the viscosity of the ink near the nozzle increases, and as a result, ink cannot be discharged through the nozzle 51 even if the actuator 58 for discharge drive operates. Therefore, before such a situation arises (within the viscosity range in which ink can be discharged by the action of the actuator 58), the actuator 58 is allowed to act against the ink receiver to perform “preliminary discharge” to discharge ink with increased viscosity near the nozzle. Preliminary discharge is also performed after cleaning contaminants on the surface of the nozzle plate by a wiper such as a cleaning blade 66 disposed as a cleaning device for the nozzle face 50A so as to prevent contaminants entering into the nozzle 51 by the sliding of the wiper. The preliminary discharge is also called “dummy discharge”, “purge” or “liquid discharge”.

On the other hand, when bubbles are introduced into the nozzle 51 or the pressure chamber 52 or when the increase in the viscosity of the ink in the nozzle 51 exceeds a certain level, ink cannot be discharged by means of the above preliminary discharge. In such a case, the cap 64, which is a suction device, is brought into contact with the nozzle face 50A of the printing head 50, and the ink in the pressure chamber 52 (ink to which bubbles are introduced or thickened ink) is sucked by a suction pump 67. The ink removed by such suction operation is sent to a recovery tank 68. The ink collected in the recovery tank 68 may be reused or discarded when not reusable.

The above suction operation is performed for the entire ink in the pressure chamber 52, and so a large amount of ink is consumed. Therefore, when the increase in the viscosity is small, preferably preliminary discharge is performed. The above suction operation is also performed upon initial charge of ink to the printing head 50 or upon restart after long suspension.

The feeding system of the treating liquid is not shown, but is substantially the same as the configuration of the ink feeding system described in FIG. 6.

[Description of Control System]

FIG. 7 is a block diagram of essential parts illustrating a system configuration of the inkjet recording apparatus 10. The inkjet recording apparatus 10 is equipped with a communications interface 70, a system controller 72, an image memory 74, a ROM 75, a motor driver 76, a heater driver 78, a solvent absorbing roller driver 79, a print control 80, an image buffer memory 82, a treating liquid head driver 83 and an ink head driver 84.

The communications interface 70 is an interface which receives image data sent from a host computer 86. A serial interface such as USB, IEEE 1394, Ethernet or wireless network or a parallel interface such as Centonics interface may be applied as the communications interface 70. A buffer memory (not shown) may also be installed in this part for accelerating communication.

The image data transmitted from the host computer 86 is imported into the inkjet recording apparatus 10 through the communications interface 70 and once stored in the image memory 74. The image memory 74 once is a memory device which stores images inputted through the communications interface 70, and read/write of the data is done through the system controller 72. The image memory 74 is not limited to memories composed of a semiconductor element and a magnetic medium such as hard disk may also be used.

The system controller 72 is composed of a central processing unit (CPU) and peripheral circuits, and functions as a control unit which controls the entire inkjet recording apparatus 10 based on a pre-determined program and also functions as an arithmetic unit which performs various operations. More specifically, the system controller 72 controls components including the communications interface 70, the image memory 74, the motor driver 76 and the heater driver 78, controls communication with the host computer 86, controls read/write in the image memory 74 and produces control signals for controlling the motor 88 and the heater 89 in the carrying system.

The ROM 75 stores programs executed by the CPU in the system controller 72 and various data necessary for control. The ROM 75 may be a non-rewritable memory or a rewritable memory such as EEPROM. The image memory 74 is used as a temporary storing area of image data, a program deployment area and a work area for the operation of CPU.

The motor driver 76 is a driver (driving circuit) which drives the motor 88 based on the instruction from the system controller 72. The heater driver 78 is a driver which drives the heater 89 in the drying unit, heating unit 17 based on the instruction from the system controller 72.

The print control 80 has a function of processing signals to perform various processing or correction for producing signals for control of printing from image data in the image memory 74 in accordance with the control of the system controller 72. The print control 80 sends the produced printing data (dot data) to the treating liquid head driver 83 and the ink head driver 84.

The print control 80 has an image buffer memory 82 in which image data or data such as parameters are temporarily stored upon processing of image data in the print control 80. In FIG. 7, the image buffer memory 82 is described in a mode that it is attached to the print control 80, but the image memory 74 may also serve as the image buffer memory 82. Further, a mode in which the print control 80 and the system controller 72 are integrated to constitute one processor is also possible.

An outline of processing flow from image input to printing output is that the data of an image to be printed is inputted from the outside through the communications interface 70 and stored in the image memory 74. At this stage, for example, image data of RGB is stored in the image memory 74.

In the inkjet recording apparatus 10, images which appear to have continuous tone to the human eye are formed by changing the density of ejection of fine dots or the dot size of the ink (color material). Therefore, it is necessary to convert the input to dot patterns which reproduce the tone of the inputted digital image (shading of image) as precisely as possible. To this end, the data of the original image (RGB) stored in the image memory 74 is transmitted to the print control 80 through the system controller 72, and converted to dot data corresponding to each ink color in the print control 80 according to a halftoning technique such as dithering or error diffusion.

More specifically, the print control 80 converts the inputted RGB image data to dot data of four colors of K, C, M, Y. The print control 80 discriminates the ejection region of a treating liquid (region on the recording surface where the treating liquid is to be ejected) based on the dot data of the respective colors, and produces dot data for ejecting the treating liquid. The dot data (for the treating liquid and the respective colors) thus produced in the print control 80 is stored in the image buffer memory 82.

The treating liquid head driver 83 generates a drive control signal for the head 11 for a treating liquid based on the dot data for ejecting the treating liquid stored in the image buffer memory 82. When the drive control signal generated in the treating liquid head driver 83 is given to the head 11 for a treating liquid, the treating liquid is discharged through the head 11 for a treating liquid.

Likewise, the ink head driver 84 generates a drive control signal for the printing head 50 based on the dot data for ejecting ink stored in the image buffer memory 82. When the drive control signal generated in the ink head driver 84 is given to the printing head 50, ink is discharged through the printing head 50. The treating liquid head driver 83 and the ink head driver 84 each may also have a feedback control system for maintaining the drive condition of the heads constant.

An image is formed on the recording medium 16 by controlling discharge of the treating liquid from the head 11 for a treating liquid and discharge of ink through the printing head 50 while synchronizing with the traveling speed of the recording medium 16.

As described above, the amount and the timing of discharge of droplets through the respective nozzles are controlled by means of the treating liquid head driver 83 and the ink head driver 84 based on the dot data produced through necessary signal processing in the print control 80. This control provides the dot size and the dot position desired.

The inkjet recording apparatus 10 in this embodiment is further composed of an ink data reading unit 90, a treating liquid data reading unit 92 and a media kind detection unit 94. The ink data reading unit 90 is a device which receives the data of the kind of ink. Specifically, for example, a device which detects the shape of the cartridge of the ink tank 60 (see FIG. 6) (specific shape by which the kind of ink can be identified) or reads the identification data or the property data of the ink through a barcode or an IC chip built in a cartridge may be used. Or an operator may input necessary information using a user interface.

Likewise, a treating liquid data reading unit 92 is a device which receives the data of the kind of treating liquids. Specifically, for example, a device which detects the shape of the cartridge of the treating liquid tank (specific shape by which the kind of liquid can be identified) or reads the identification data or the property data of the treating liquid through a barcode or an IC chip built in a cartridge may be used. Or an operator may input necessary information using a user interface.

The media kind detection unit 94 is a device which detects the kind of recording media (paper kind) and the size thereof. For example, a device which reads data (identification data or data of the media kind) in a barcode attached to a magazine 19 of a medium feeding unit 18 or a sensor disposed at an appropriate position along the medium carrying line (a sensor for detecting the width of the medium, a sensor for detecting the thickness of the medium, a sensor for detecting the reflectance of the medium) is used. Combination thereof is also possible. In addition to or in combination with such automatic detection devices, a configuration in which the data of the kind and the size of paper is specified based on the input from a certain user interface is also possible.

The information obtained from the ink data reading unit 90, the treating liquid data reading unit 92 and the media kind detection unit 94 is sent to the system controller 72 and used for controlling discharge of a treating liquid and ink (control of the amount and the timing of discharge), and appropriate ejection is performed in accordance with the conditions. Specifically, the system controller 72 analyzes the permeation rate characteristic of the recording medium 16 based on the information obtained from the ink data reading unit 90, the treating liquid data reading unit 92 and the media kind detection unit 94, determines whether the treating liquid is used or not, and controls the amount of discharge if the treating liquid is used.

For example, the inkjet recording apparatus 10 has an information storage device (e.g., ROM 75 shown in FIG. 7 or internal memory or external memory which is not shown) which stores data of the media kind table in which the media kind and the permeation rate characteristics are linked. The system controller 72 refers to the media kind table and assesses the permeation rate characteristic of the recording medium 16 to be used.

For assessing the permeation rate characteristic of the recording medium 16, ID (identification data) of the medium may be obtained from the media kind detection unit 94 to assess the permeation rate characteristic of the medium with reference to the media kind table, or data indicating the permeation rate characteristic of the medium may be recorded on an information recording body such as a barcode attached to a magazine and then the data of the permeation rate characteristic of the medium is directly read from the media kind detection unit 94.

Alternatively, a device for actually measuring the permeation rate of the recording medium 16 can be used. For example, ink or treating liquid, or both are ejected on the recording medium 16, and conditions of dots formed by the test ejection are read by a detection device such as an imaging device (not shown), and the permeation rate can be calculated according to the obtained data.

As described in FIG. 1, the inkjet recording apparatus 10 in this embodiment has a head 11 for a treating liquid at the upstream of the printing unit 12, providing a configuration in which a treating liquid is applied in advance to the printing surface of the recording medium 16 only once through the preceding (upstream) head 11 for a treating liquid before ejecting ink through the printing unit 12. In such a configuration, along with the increase in the amount of ejection of ink through the printing unit 12, the amount of the treating liquid on the recording medium 16 gradually decreases, and therefore the amount of the treating liquid on the recording medium 16 is smaller at the downstream of the printing unit 12. Since the treating liquid must remain in the vicinity of the surface of the recording medium 16 until completion of the ejection through the last (most downstream) printing head (head 12Y for yellow in FIG. 1) in the printing unit 12, the amount of ejection of the treating liquid through the head 11 for a treating liquid is determined from the kind of the recording medium 16, physical properties of the treating liquid, the amount of discharge of ink and the traveling speed of the recording medium 16 so as to ensure the required amount of the treating liquid.

Further, the system controller 72 shown in FIG. 7 controls the solvent absorbing roller driver 79 according to the thickness and the permeation rate characteristic of the recording medium 16, and appropriately controls the vertical position (the contact pressure to the recording medium 16 or the amount of clearance relative to the recording medium 16) and the rotation speed of the solvent absorbing roller 15. The solvent absorbing roller driver 79 is a device for controlling the position of the solvent absorbing roller 15 against the recording surface of the recording medium 16 and the rotation speed thereof. The driver is composed of a vertical motion mechanism for moving the solvent absorbing roller 15 up and down, a motor (actuator) and a driver which are a power source for driving the mechanism electrically, a power transmission mechanism (a belt, a pulley, a gear or an appropriate combination thereof) for transmitting the drive force of the motor to the vertical motion mechanism, a motor and a driver which are a power source for rotating the solvent absorbing roller 15, a power transmission mechanism, and a heater driver for the heating unit 17 for heating and drying an agglomerate generated on the recording medium 16.

[Description of Image Forming Process]

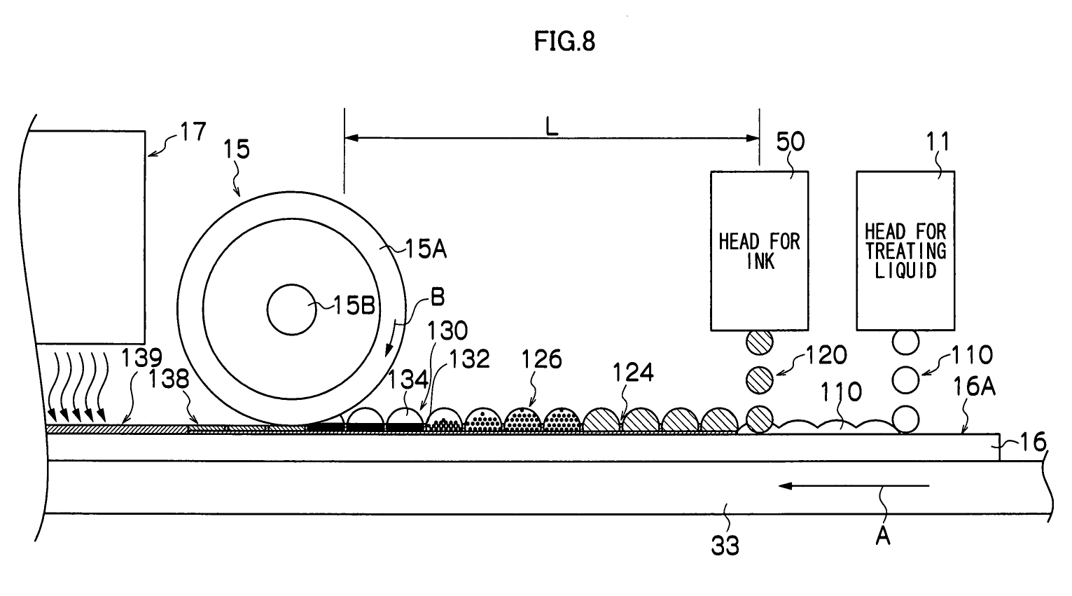

The image forming process in the inkjet recording apparatus 10 in this embodiment is now described. FIG. 8 is an enlarged schematic view illustrating an essential construction near the printing unit 12 of the inkjet recording apparatus 10. Although only one head for ink (printing head 50) is described in the subsequent stage of the head 11 for a treating liquid in the figure for simplification of the representation, the actual printing unit 12 has printing heads 12K, 12C, 12M, 12Y for four colors as described in FIG. 1.

In FIG. 8, the recording medium 16 is transferred from right to left. The image forming process is as follows.

(Step 1) Droplets of a treating liquid 110 are discharged through a head 11 for a treating liquid disposed at the upstream in the traveling direction of a recording medium (the direction of arrow A in FIG. 8) to apply the treating liquid 110 to the recording surface 16A of the recording medium 16 in advance.

(Step 2) Droplets of ink 120 are discharged through a printing head 50 disposed at the downstream of the head 11 for a treating liquid, and the ink 120 reaches the recording medium 16 while the liquid component of the treating liquid 110 still remains on the surface.

(Step 3) Upon mixing of the treating liquid 110 and the ink 120 on the surface of the recording medium 16, agglomeration reaction of anionic groups in a low molecular weight dispersant dispersed in the ink 120 together with a color material occurs due to pH change upon contact with the treating liquid 110. This makes the color material and other components in the ink 120 agglomerate and a color material agglomerate 126 is produced.

(Step 4) Then, as shown in FIG. 8, the color material agglomerate 126 is settled down on the recording medium 16 (downward). A droplet (dot) 130 of the ink 120 on the recording medium 16 is separated into a color material layer 132 composed of the color material agglomerate 126 that has been settled and a layer of solvent 134.

(Step 5) Droplets 130 separated into the color material layer 132 and the solvent 134 are transferred to the position of the solvent absorbing roller 15 as the recording medium 16 is transferred (in the direction of arrow A in FIG. 8). When the solvent 134 of the droplets 130 is brought into contact with the solvent absorbing roller 15, the solvent 134 is absorbed to the solvent absorbing roller 15 by the capillary attraction of the porous member 15A. The solvent absorbing roller 15 rotates in the direction of arrow B in FIG. 8 according to the traveling speed of the recording medium 16 in such a manner that the relative speed with respect to the recording medium 16 is 0, preventing disturbance of images due to rubbing of ink. As a polymer film 124 is formed around each dot 130 at this stage, movement of the color material on the recording medium 16 is restrained and attachment of the color material to the solvent absorbing roller 15 is prevented, and therefore disturbance of images hardly occurs. In other words, since the film 124 is present between dots even when the solvent is absorbed to the solvent absorbing roller 15, the film 124 plays a role of restraining movement of the ink and preventing disturbance of images upon contact of the solvent absorbing roller 15 and the ink.

The position of the printing head 50 and the solvent absorbing roller 15 (distance L from the landing position to the solvent contact position) and the traveling speed of the recording medium 16 are determined so that the time from the landing of the ink 120 discharged through the printing head 50 (i.e., at the time of mixing of two liquids) to the contact of the solvent 134 to the solvent absorbing roller 15 is longer than the time for completion of the separation of color material/solvent by the reaction of two liquids.

(Step 6) Thus, the ink (reference numeral 138 in FIG. 8) from which excess solvent is removed by the solvent absorbing roller 15 has an increased binding force of color materials, and then is fixed to the recording medium 16. This prevents occurrence of blurring and produces effects of preventing bleeding between colors, facilitating drying and fixing and preventing cockling.

(Step 7) Subsequently, hot air heated to about 30° C. by the heating unit 17 is applied to the recording medium 16 to further evaporate the solvent component contained in the color material agglomerate 126 and dry the agglomerate. Then, polymer fine particles dispersed together with the color material are dried and cured to form a film, and the color material is firmly fixed to the recording medium 16 (reference numeral 139). Since the polymer fine particles are hydrophobic, water resistance is also improved. Accordingly, print excellent in scratch resistance, water resistance and fixing properties is formed.

### EXAMPLES

The present invention is now described in more detail by means of Examples, but the present invention is not limited to the following Examples.

[Preparation of Ink and Treating Liquid]

### (1-1) Preparation of Magenta Ink M-10

First, a dispersion was prepared by mixing, with stirring, 10.0 g of Cromophtal Jet Magenta DMQ (PR-122) available from Ciba Specialty Chemicals, 1.0 g of low molecular weight dispersant 2-1 (molecular weight 339.5) , 4.0 g of glycerol and 35.0 g of ion exchange water. The dispersion was intermittently irradiated (irradiation 0.5 s/non-irradiation 1.0 s) with ultrasonic wave using an ultrasonic irradiation apparatus (Vibra-cell VC-750 made by Sonics & Materials Inc., tapered microchips: φ5 mm, amplitude: 30%) for two hours to further disperse the pigment therein, whereby a 20% by mass pigment dispersion was prepared.

Separately from this, the following compounds were weighed and mixed with stirring to prepare a mixture I.

glycerol: 5.0 g

diethylene glycol: 10.0 g

OLFINE E1010 (available from Nisshin Chemical Industry Co. Ltd.): 1.0 g

ions exchange water: 1.0 g

The mixture I was gradually added dropwise to 23.0 g of a 44% SBR dispersion (polymer fine particles; acrylic acid 3% by weight, Tg 30° C.) which was stirred, and the mixture was mixed with stirring to prepare a mixture II. The mixture II was gradually added dropwise to the above-described 20% pigment dispersion, and the mixture was mixed with stirring to prepare 100 g of Magenta ink M-2 (Example 1). Further, an ink prepared in the same manner as in the case of preparing Magenta ink M-10 except that the low molecular weight dispersant of Magenta ink M-10 was changed to compound 4 (N-oleoyl-N-methyltaurine sodium, molecular weight 425.6) from compound 2-1 was named Magenta ink M-11 (Example 2).

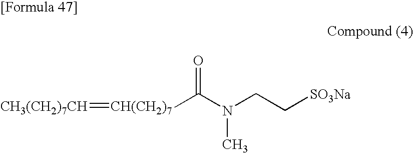

The pKa of the low molecular weight dispersant was determined from a titration curve obtained by titration of a solution of the low molecular weight dispersant dissolved in tetrahydrofuran/water (tetrahydrofuran: water=3:2=V/V) at 1 mmol/L with aqueous hydrochloric acid. Compound 2-1 has a pKa of 5.8 and Compound 4 has a pKa of 2 or less.

Inks prepared in the same manner as in the case of preparing Magenta ink M-10 except that the amount of SBR (styrene-butadiene latex) of Magenta ink M-10 was changed were each named Magenta ink M-12 to M-14 in the following Table 3 (Examples 3 to 5).

Inks prepared in the same manner as in the case of preparing Magenta ink M-10 except that the amount of a fluorine surfactant Zonyl-FSA (available from DuPont) to the total amount of the ink in Magenta ink M-10 was changed were named Magenta ink M-15 to M-17 in the following Table 3 (Examples 6 to 8).

Inks prepared in the same manner as in the case of preparing Magenta ink M-10 except that the amount of pigment and SBR in Magenta ink M-10 were changed were named Magenta ink M-21 to M-22 in the following Table 3 (Examples 9 to 10).

[Table 3]

TABLE 3
(unit: % by weight)

| | | Low molecular | | | | | | | |
|---|---|---|---|---|---|---|---|---|---|
| | | weight | | | | Diethylene | Ion exchange | OLFINE | Fluorine |
| | Ink | dispersant | Pigment | SBR | Glycerol | glycol | water | E1010 | surfactant |
| Ex. 1 | M-10 | Compound 2-1 | 10 | 10 | 10 | 10 | Rest | 1 | None |
| Ex. 2 | M-11 | Compound 4 | 10 | 10 | 10 | 10 | Rest | 1 | None |
| Ex. 3 | M-12 | Compound 2-1 | 10 | 7.5 | 10 | 10 | Rest | 1 | None |
| Ex. 4 | M-13 | Compound 2-1 | 10 | 5 | 10 | 10 | Rest | 1 | None |
| Ex. 5 | M-14 | Compound 2-1 | 10 | 2.5 | 10 | 10 | Rest | 1 | None |
| Ex. 6 | M-15 | Compound 2-1 | 10 | 10 | 10 | 10 | Rest | 1 | 0.1 |
| Ex. 7 | M-16 | Compound 2-1 | 10 | 10 | 10 | 10 | Rest | 1 | 0.01 |
| Ex. 8 | M-17 | Compound 2-1 | 10 | 10 | 10 | 10 | Rest | 1 | 0.001 |
| Ex. 9 | M-21 | Compound 2-1 | 4 | 8 | 20 | 10 | Rest | 1 | None |
| Ex. 10 | M-22 | Compound 2-1 | 4 | 16 | 10 | 10 | Rest | 1 | None |
| Com. Ex. 1 | M-1 | Compound 2-1 | 10 | 0 | 10 | 10 | Rest | 1 | None |
| Com. Ex. 2 | M-2 | Polymer | 10 | 0 | 0 | 10 + Ethylene | Rest | 1 | None |
| | | dispersant | | | | glycol 10 | | | |
| | | Molecular | | | | | | | |
| | | weight35000 | | | | | | | |

### (1-2) Preparation of Ink M-1 of Comparative Example 1 (Without Addition of Polymer Fine Particles)

Magenta ink M-1 of Comparative Example 1 was prepared in the same manner as in the above-described Example 1, except that SBR (styrene-butadiene latex) was not added (Comparative Example 1).

### (1-3) Preparation of Ink M-2 of Comparative Example 2 (Using a Polymer Dispersant Having a Molecular Weight Higher Than 2000)

First, a reactor was charged with the following monomers of initial charge (monomers, polymerization chain transfer, etc.) and 20 parts by mass of methyl ethyl ketone to prepare a mixture III. The inside air was completely replaced with nitrogen gas.

(Initial Charge Monomer)

methacrylic acid: 8 parts by mass

styrene: 21 parts by mass

dodecyl methacrylate: 3 parts by mass

(available from SHIN-NAKAMURA CHEMICAL CO. LTD., product name: NK Ester M-230 G)

M-230 G: 5 parts by mass

methoxy-terminated polyethylene glycol (23 moles)

styrene macromer: 6 parts by mass

(available from TOAGOSEI Co., Ltd., product name: AS-6S (styrene homo-polymerized macromer, number average molecular weight: 6000, polymerizable functional group: methacryloyloxy group))

mercaptoethanol: 0.2 part by mass

On the other hand, 60 parts by mass of methyl ethyl ketone and 1.2 parts by mass of 2,2′-azo-bis (2,4-dimethylvaleronitrile) were added to the following dropping monomers (monomers, polymerization chain transfer, etc.) in a dropping funnel to prepare a mixture IV. The inside air was completely replaced with nitrogen gas.

(Dropping Monomers)

methacrylic acid: 7 parts by mass

styrene: 36 parts by mass

dodecyl methacrylate: 4.6 parts by mass

M-230 G 5 parts by mass

styrene macromer: 7 parts by mass

mercaptoethanol: 0.2 part by mass

The mixture III in the reactor was heated to 70° C. with stirring under nitrogen atmosphere, and thereto was gradually added dropwise the mixture IV in the dropping funnel over 3 hours. Two hours after the completion of the dropping of the mixture IV, thereto was added a solution in which 0.3 part by mass of 2,2′-azo-bis (2,4-dimethylvaleronitrile) was dissolved in 5 parts by mass of methyl ethyl ketone. The mixture was aged at 7020 C. for 2 hours and 75° C. for 2 hours to obtain a polymer solution. Then, part of the polymer solution was dried under reduced pressure at 105° C. for 2 hours to remove the solvent, and as a result, a polymer dispersant of Comparative Example 2 was synthesized.

The weight average molecular weight of the polymer dispersant was measured by gel permeation chromatography using polystyrene as a reference material and 50 mmol/L acetic acid containing tetrahydrofuran as a solvent. As a result, the molecular weight was 35000. 10% by mass of the polymer dispersant, 10% by mass of an organic pigment (the same pigment as in Example 1), 10% by mass of ethylene glycol, 10% by mass of diethylene glycol and 1% by mass of OLFINE E1010 were mixed to prepare ink M-2 of Comparative Example 2.

### (1-4) Preparation of Treating Liquid

The following compounds were weighed and the mixture was stirred to prepare a treating liquid.

diethylene glycol: 20.0 g

OLFINE E1010: 1.0 g

2-pyrrolidone-5-carboxylic acid 1.0 g

sodium hydroxide: 0.25 g

ions exchange water: 77.8 g

The pH of the treating liquid was measured by pH meter WM-50EG made by DKK-TOA Corporation, and the pH was 3.5.

The viscosity, dischargeability, fixing properties, scratch resistance and water resistance of the ink prepared in Examples 1 to 10 and Comparative Examples 1 to 2 as described above were evaluated by the following methods. The measurement results are shown in Table 4 described below.

[Measurement of Viscosity]

The viscosity was measured using DV-II+VISCOMETER made by BROOKFIELD.

[Evaluation of Dischargeability]

The ink cartridge of PX-G920 made by SEIKO EPSON CORPORATION was refilled with the ink in the above-described Table 1. A nozzle check pattern was printed to assess the ratio of nozzles through which the ink was discharged. The evaluation results are shown in Table 4 according to the following criteria.

G: discharge from all nozzles, M: discharge from 95% or more of the nozzles, P: discharge from 90% or less of the nozzles

[Evaluation of Fixing Properties]

Ink was applied to A6 size Tokubishi double-sided Art N (available from MITSUBISHI PAPER MILLS LIMITED) in an ink thickness of about 5 μm with a bar (bar No. 3) and dried for 24 hours. Subsequently, Scotch tape was stuck to the sample to which the ink was applied and color transfer upon peeling was evaluated. The evaluation results are shown in Table 4 according to the following criteria.

E: no color transfer observed, G: slight color transfer observed, M: color transfer observed (the same level as that of EPSON PX-V500 ink), P: significant color transfer observed

[Evaluation of Scratch Resistance]

Tokubishi double-sided Art N (available from MITSUBISHI PAPER MILLS LIMITED) was put over the ink-applied sample used in the evaluation of fixing properties and pressed against the sample with fingers. The sample was rubbed with the art paper put thereon back and forth 20 times in a width of 2 cm, and the color transfer was evaluated. The measurement results in the experiment are shown in Table 4 according to the following criteria.

E: no color transfer observed, G: slight color transfer observed, M: color transfer observed, P: significant color transfer observed

[Evaluation of Water Resistance]

A droplet of water (30 μl) was dropped to the ink-applied sample used in the evaluation of fixing properties with a pipette. The water resistance was evaluated based on color transfer when water was wiped off with KayDry after one minute. The measurement results in the experiment are shown in Table 4 according to the following criteria.

G: no color transfer observed, M: slight color transfer observed

[Table 4]

TABLE 4

| | | Ink | | | | | |
|---|---|---|---|---|---|---|---|
| | | viscosity | | Fixing | Scratch | Water | |
| | Ink | mPa · s | Dischargeability | properties | resistance | resistance | Remarks |
| Ex. 1 | M-10 | 5.5 | G | G | E | G | Present |
| | | | | | | | invention |
| Ex. 2 | M-11 | 5.4 | G | G | E | M | Present |
| | | | | | | | invention |
| Ex. 3 | M-12 | 4.5 | G | G | G | G | Present |
| | | | | | | | invention |
| Ex. 4 | M-13 | 3.8 | G | G | M | G | Present |
| | | | | | | | invention |
| Ex. 5 | M-14 | 3.5 | G | G | M | G | Present |
| | | | | | | | invention |
| Ex. 6 | M-15 | 5.5 | G | E | E | G | Present |
| | | | | | | | invention |
| Ex. 7 | M-16 | 5.6 | G | E | E | G | Present |
| | | | | | | | invention |
| Ex. 8 | M-17 | 5.4 | G | E | G | G | Present |
| | | | | | | | invention |
| Ex. 9 | M-21 | 5.3 | G | E | E | G | Present |
| | | | | | | | invention |
| Ex. | M-22 | 5.5 | G | E | E | G | Present |
| 10 | | | | | | | invention |
| Com. | M-1 | 3.0 | G | P | P | G | Com. Ex. |
| Ex. 1 | | | | | | | |
| Com. | M-2 | 9.8 | P | G | G | G | Com. Ex. |
| Ex. 2 | | | | | | | |

The inks of Examples 1 to 10 of the present invention containing a low molecular weight dispersant having a molecular weight of 339.5 and polymer fine particles (SBR) all successfully have a low viscosity of 5.6 mPa·s or lower. Accordingly, no clogging of nozzles occurred and excellent dischargeability of ink was achieved. In addition, properties of ink such as fixing properties to recording media, scratch resistance and water resistance were generally good although they were different depending on the composition of the ink.

On the other hand, the ink of Comparative Example 2 in which a polymer dispersant having a molecular weight of 35000 was used had a high viscosity of 9.8 mPa·s, and as clogging occurred in some nozzles, the dischargeability was found to be poor.

Further, although the ink of Comparative Example 1 which does not contain polymer fine particles (SBR) has low viscosity and good ink dischargeability, it has been found that the ink had poor fixing properties to recording media and poor scratch resistance.

These results show that the ink of the present invention containing both a low molecular weight dispersant and polymer fine particles (SBR) is excellent in ink discharge stability, fixing properties to recording media, scratch resistance and water resistance.

Further, the effects of the amount of SBR and the presence of a fluorine surfactant on the scratch resistance and the fixing properties were studied. As a result, it has been found that the smaller the amount of SBR, the lower the scratch resistance as shown in Examples 1, 3 to 5, 9, 10, and Comparative Example 1 in Table 4. The study has also confirmed that the viscosity of the ink slightly increases when the amount of SBR in the present Examples is increased, but the dischargeability of the ink is not affected.

It has also been proved that the scratch resistance and the fixing properties are further improved by adding a fluorine surfactant as shown in Examples 1, 6 to 8.

On the other hand, the ink of Comparative Example 1 which does not contain SBR or a fluorine surfactant had poor scratch resistance and fixing properties.

These results show that SBR provides ink with fixing properties to art paper and bind color materials together to improve the scratch resistance on the applied surface. Further, for achieving good discharge stability, fixing properties and scratch resistance of ink, preferably the mass ratio P/C of the mass P of the polymer fine particles to the mass C of the organic pigment is 0.5 to 4.0. Presumably, the fluorine surfactant improves fixing properties and scratch resistance by increasing slipping of the coated surface.

Further, the effect of the kind of the low molecular weight dispersant on the water resistance was studied (see Examples 1, 2 in Table 4). As a result, while no color transfer was found in the ink in Example 1 containing a carboxylic acid group as a hydrophilic group of the low molecular weight dispersant, a small degree of color transfer was found in the ink of Example 2 which contains a sulfonate group. This seems to be because carboxylic acid groups are difficult to be dissociated (as they are weak acid) when water is added compared to sulfonate groups.

These findings show that the ink using a low molecular weight dispersant containing a carboxylic acid group as a hydrophilic group has higher water resistance.

Finally, occurrence of drop interference was examined using the ink set of the present invention. The ink of Examples 1 and 2 and the ink of Comparative Example 2 were examined below.

[Evaluation of Drop Interference]

The head in IUET 1000 made by MicroJet was fixed, and Tokubishi double-sided Art N (A6 size) to which a treating liquid was applied by a No. 3 bar was put on a portable stage. The droplet amount per 1 dot was adjusted to 120 pL, and the ink and/or the treating liquid were ejected under conditions of a discharge frequency of the head of 1 kHz and an operating speed of the stage of 100 mn/s (the center distance of adjacent dots was set at 100 μm, the time before ejecting an adjacent dot was set at 1 millisecond) to form a line.

Then, with changing the time from the ejection of the treating liquid to the ejection of the ink, preservability of dot shape was compared (evaluation of drop interference). The preservability of dot shape was evaluated by visual observation of samples on which a line was formed by an optical microscope at a magnification of 200. The measurement results in the experiment are shown in Table 5 according to the following criteria.

E: border between dots easily recognized

G: border between dots somehow recognized

P: border between dots not recognized (dots are combined, drop interference occurred)

[Table 5]

TABLE 5

| | | |
|---|---|---|
| Ink | Evaluation | Remarks |

| | | | |
|---|---|---|---|
| Ex. 1 | M-11 | E | Present invention |
| Ex. 2 | M-11 | G | Present invention |
| Com. Ex. 2 | M-2 | P | Com. Ex. (no treating liquid applied) |

The finding is that when ejection was performed using an ink set composed of an ink and a treating liquid as in Examples 1 and 2 in Table 5, no drop interference occurred and high quality dots could be formed. In particular, in the case of using the treating liquid of the present Example, drop interference was significantly low in the ink of Example 1 in which a low molecular weight dispersant containing a carboxylic acid group was used. This seems to be because the relation between the dissociation constant of the low molecular weight dispersant and the acidity of the treating liquid made it easier to form agglomerates and this could prevent blurring.

On the other hand, when the ink of Comparative Example 2 alone was ejected, the drop interference was so remarkable that the border of dots could not be observed.

The above results prove that use of the ink set of the present invention in which an ink and a treating liquid are combined can prevent drop interference.

Although magenta was used as an organic pigment in the present Examples, the advantage of the present invention can also be obtained by using other organic pigments such as cyan pigment P.B 15:3 or yellow pigment P.Y 155.

As described above, by using the ink set and the method and the apparatus for recording an image of the present invention, high quality, high definition images can be formed at high speed with excellent ink discharge stability.

What is claimed is:

1. An ink set comprising an ink containing at least an organic pigment, a water-soluble organic solvent and water and a treating liquid which is applied to a recording medium before applying the ink to the recording medium and produces an agglomerate upon contact with the ink,
the ink containing a low molecular weight dispersant having a molecular weight of 2000 or lower and polymer fine particles.

2. The ink set according to claim 1, wherein the treating liquid is acidic.

3. The ink set according to claim 1, wherein the low molecular weight dispersant has a pKa relative to a dissociation constant Ka of 3 or more.

4. The ink set according to claim 1, wherein the low molecular weight dispersant has a chemical structure containing a carboxylic acid group or a salt thereof.

5. The ink set according to claim 1, wherein the low molecular weight dispersant is represented by the following Formula (1): 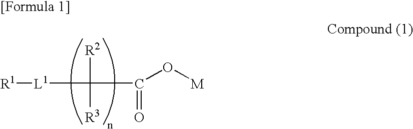
wherein L¹ represents a single bond or a divalent linking group, R¹ represents a substituent, R² and R³ each represent a hydrogen atom or a substituent, M represents a hydrogen atom or a monovalent cation and n represents an integer of 1 or more, provided that R¹ to R³ do not contain a sulfonic acid group and have 13 or more carbon atoms in total.

6. The ink set according to claim 5, wherein L¹ in the Formula (1) is an amide group, a sulfonamide group, an ester group, an ether group or a sulfide group.

7. The ink set according to claim 1, wherein the low molecular weight dispersant is represented by the following Formula (2) or (3): 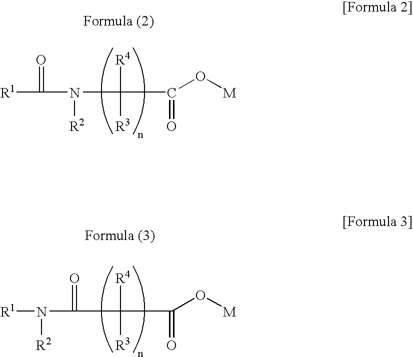
wherein R¹ represents a substituent, R², R³ and R⁴ each represent a hydrogen atom or a substituent, M represents a hydrogen atom or a monovalent cation and n represents an integer of 1 to 10, provided that R¹ to R⁴ do not contain a sulfonic acid group and have 13 or more carbon atoms in total.

8. The ink set according to claim 1, wherein the polymer fine particles have a glass transition temperature Tg of 30° C. or higher.

9. The ink set according to claim 1, wherein the polymer fine particles are a styrene latex or an acrylic latex.

10. The ink set according to claim 1, wherein a mass ratio P/C of a mass P of the polymer fine particles contained in the ink to a mass C of the organic pigment contained in the ink is 0.5 to 4.0.

11. The ink set according to claim 1, wherein the ink contains a fluorine surfactant.

12. The ink set according to claim 1, which is an ink set for inkjet.

13. A method for recording an image using the ink set of claim 1, comprising a step of:
applying the treating liquid in the ink set to a recording medium and then applying the ink in the ink set to the treating liquid, thereby forming an image.

14. The method for recording an image according to claim 13, wherein the treating liquid is acidic and the acidity of the ink changes upon contact with the treating liquid to produce an agglomerate.

15. The method for recording an image according to claim 13, which is an inkjet recording method.

16. An apparatus for recording an image using the ink set of claim 1, comprising:
a first application device which applies the treating liquid in the ink set to a recording medium,
a second application device which applies the ink in the ink set to the treating liquid and
a heating device which heats an agglomerate produced upon contact between the ink and the treating liquid.
